(19) United States
(12) Patent Application Publication
(10) Pub. No.: US 2026/0214293 A1
(43) Pub. Date: Jul. 23, 2026

(54) MOBILE TERMINAL AND SYSTEM

(71) Applicant: ARTYGEN SPACE CO., LTD., Seoul (KR)

(72) Inventor: Youngsun SEO, Seoul (KR)

(73) Assignee: ARTYGEN SPACE CO., LTD., Seoul (KR)

(21) Appl. No.: 19/140,484

(22) PCT Filed: Nov. 28, 2023
(86) PCT No.: PCT/KR2023/019322

§ 371 Date: Jun. 18, 2025

(30) Foreign Application Priority Data
Dec. 20, 2022 (KR) 10-2022-0178923
Mar. 24, 2023 (KR) 10-2023-0038317

(51) Int. Cl. H04N 21/431; G06V 20/20; G06V 20/50; H04N 21/414; H04N 23/63

(52) U.S. Cl. CPC H04N 21/4316; G06V 20/20; G06V 20/50; H04N 21/41407; H04N 23/63

(57) ABSTRACT

Disclosed is a mobile terminal and system that allows one video to be randomly played among a plurality of videos stored in association with an image. The disclosed mobile terminal: extracts a target image from a captured image captured by a camera; extracts a subject image corresponding to the target image from candidate images; receives, from a server, image content selected according to a predetermined rule from among a plurality of pieces of image content associated with the extracted subject image; and plays the received image content overlaying at least a partial area of the captured image on a display.

### TECHNICAL FIELD

The present disclosure relates to a mobile terminal and a system, and more particularly, to a mobile terminal and a system which can play back a video associated with an image.

### BACKGROUND ART

As the supply of smartphone terminals is increased, performance of the smartphone terminal, such as the CPU, the picture quality of a camera, and a memory storage space, is improved as days go by, and the speed of a wireless communication network also tends to become fast.

Accordingly, there is a tendency toward the provision of various forms of Internet services and multimedia services out of a mobile communication service focused on voice calls.

In particular, services using multimedia content, such as videos or advertising, are greatly increased without being limited to the watching of various images through the Internet. Moreover, a case in which images and videos are provided through the Internet and mobile communication networks by using the smartphones is greatly increased along with the recently rapid supply of smartphones.

In this aspect, there is a need to provide videos or various forms of additional services based on an image automatically or in real time through a client terminal with respect to the image that is distributed through the Internet or over a network, such as a mobile communication network.

The contents described in the Background Art are to help the understanding of the background of the disclosure, and may include contents that are not a disclosed conventional technology.

### DISCLOSURE

### Technical Problem

The present disclosure has been proposed by considering the conventional circumstances, and an object of the present disclosure is to provide a mobile terminal and a system, which enable one video, among a plurality of videos stored in association with an image, to be randomly played back.

### Technical Solution

In order to achieve the object, a mobile terminal according to a preferred embodiment of the present disclosure includes a camera, a display, memory in which candidate images are stored, and a processor configured to extract a target image from a photographing image captured by the camera, extract a subject image corresponding to the target image, among the candidate images, receive image content that is selected according to a predetermined rule, among a plurality of pieces of image content associated with the extracted subject image, from a server, and play back the received image content so that the received image content overlays at least some area of the photographing image on the display.

A transmission times limit value of image content that is selected, among a plurality of pieces of image content associated with an identical subject image, is set in the server. The processor may not receive image content selected with respect to a corresponding subject image from the server when the transmission times limit value of a corresponding user is exceeded.

The processor may play back the received image content on the display in the state in which the outer trajectory of the received image content has not been matched with the outer trajectory of the target image.

The processor may play back the received image content so that the received image content overlays at least some area of the target image on the display.

The processor may determine whether the target image has been disposed in any one shape, among a plane shape and a curved shape, may play back the received image content within the outer trajectory of the target image on the display when determining that the target image has been disposed in the plane shape, and may play back the received image content on the display in the state in which the outer trajectory of the received image content has not been matched with the outer trajectory of the target image when determining that the target image has been disposed in the curved shape.

The predetermined rule may be the choice probability of each of the plurality of pieces of image content associated with the subject image.

The image content that is received with respect to an identical subject image may be different from image content that is previously received with respect to the identical subject image.

The processor may play back image content that is selected based on information on a current location of the mobile terminal, among the plurality of pieces of image content associated with the subject image, and that is received from the server so that the image content overlays at least some area of the photographing image on the display.

The processor may play back the received image content within an area of the target image on the display.

The processor may play back image content that is selected based on information on a current location of a mobile terminal, among the plurality of pieces of image content associated with the subject image, and that is received from the server within the area of the target image on the display.

Meanwhile, a method of controlling a mobile terminal according to a preferred embodiment of the present disclosure is a control method in a mobile terminal including, a camera, a display, and memory, and includes storing candidate images in the memory, extracting a target image from a photographing image captured by the camera, extracting a subject image corresponding to the target image, among the candidate images, receiving image content that is selected according to a predetermined rule, among a plurality of pieces of image content associated with the extracted subject image, from a server, and playing back the received image content so that the received image content overlays at least some area of the photographing image on the display.

Meanwhile, a system according to a preferred embodiment of the present disclosure includes a first server in which candidate images are stored and a second server in which a plurality of pieces of image content associated with each of the candidate images is stored. The second server selects image content according to a predetermined rule, among a plurality of pieces of image content associated with a subject image extracted among the candidate images, and transmits the selected image content to a mobile terminal so that the selected image content overlays at least some area of a photographing image on a display of the mobile terminal.

The first server may receive a target image from the mobile terminal and extract a subject image corresponding to the target image, among the candidate images.

The second server may select image content that is selected with respect to an identical subject image differently from image content that is previously selected with respect to the identical subject image.

The second server may perform a transmission record by associating the image content transmitted to the mobile terminal the user account of the corresponding mobile terminal.

The second server may transmit an image content collection completion event signal to the corresponding mobile terminal when the transmission record is performed by associating all of the plurality of pieces of image content associated with the subject image with the user account of the corresponding mobile terminal.

A transmission times limit value of image content that is selected, among a plurality of pieces of image content associated with an identical subject image, is set in the second server. The second server may not transmit image content selected with respect to a corresponding subject image to the mobile terminal when the transmission times limit value for a corresponding user is exceeded.

The transmission times limit value may be a transmission times limit value within a predetermined period.

A transmission time range of image content that is selected with respect to the subject image is the second server. The second server may not transmit the image content that is selected with respect to the corresponding subject image to the mobile terminal when a current time does not belong to the transmission time range.

The second server may select image content based on information on a current location of the mobile terminal, among the plurality of pieces of image content associated with the subject image.

### Advantageous Effects

According to the present disclosure having such a construction, one piece of image content, among a plurality of pieces of image content (e.g., a still image, a video, and text) stored in association with an image, can be randomly selected and played back according to a predetermined rule.

A user's interest can be aroused because several pieces of image content (e.g., a still image, a video, and text) are randomly (consecutively) played back with respect to the same image.

Different pieces of image content (e.g., a still image, a video, and text) can be collected at several locations while operating in conjunction with locations.

A degree of difficulty in the collection of image content can be increased and a reward effect for the collection of image content can be doubled because the number, time, location, etc., of the transmission or playback of image content (e.g., a still image, a video, and text) are limited.

Furthermore, the present disclosure can be used in various draw events, such as a drinking game service and a random coupon service.

### DESCRIPTION OF DRAWINGS

FIGS. 1 and 2 are diagrams for describing a basic concept of the present disclosure.

FIG. 3 is a diagram for describing a schematic operation of a system according to an embodiment of the present disclosure.

FIG. 4 is a diagram for describing a schematic operation of the system according to another embodiment of the present disclosure.

FIG. 5 is a construction diagram of the entire system according to an embodiment of the present disclosure.

FIG. 6 is an internal construction diagram of a mobile terminal illustrated in FIG. 5.

FIG. 7 is a diagram that is adopted to describe that the videos of the same subject image that is received over time are different in a mobile terminal.

FIG. 8 is a diagram that is adopted to describe a case in which the mobile terminal receives videos at several locations while operating in conjunction with the locations.

FIG. 9 is a diagram that is adopted to describe a case in which the mobile terminal receives indication contents from a server.

FIG. 10 is a diagram that is adopted to describe a case in which the mobile terminal illustrated in FIG. 5 receives an extraction command from a user.

FIG. 11 is a diagram that is adopted to describe the extraction of a target image when an edge pattern is present in a photographing image.

FIGS. 12A and 12B are diagrams illustrating another example of an edge pattern.

FIG. 13 is a diagram that is adopted to describe a case in which the outer trajectory of a target image is not a quadrangle.

FIG. 14 is a diagram that is adopted to describe an example of a case in which a target image is attached to a curved surface object.

FIGS. 15 and 16 are diagrams that are adopted to describe another example of a case in which a target image is attached to a curved surface object.

FIG. 17 is a diagram that is adopted to describe the playback of a video in the mobile terminal based on advertising in a bus station shelter.

FIG. 18 is an internal construction diagram of an image server illustrated in FIG. 5.

FIG. 19 is a diagram that is adopted to describe a case in which candidate images are stored in memory illustrated in FIG. 18 in association with a user account.

FIG. 20 is a diagram that is adopted to describe a case in which candidate images are stored in the memory illustrated in FIG. 18 in association with location information.

FIG. 21 is an internal construction diagram of a video server illustrated in FIG. 5.

FIG. 22 is a diagram that is adopted to describe a case in which a video collection completion event signal is transmitted from the server to the mobile terminal.

FIG. 23 is a flowchart for describing a control method in the mobile terminal according to an embodiment of the present disclosure.

FIG. 24 is a flowchart for describing a control method in the server according to an embodiment of the present disclosure.

FIG. 25 is a flowchart for describing a control method in the mobile terminal according to another embodiment of the present disclosure.

FIG. 26 is a flowchart for describing a control method in the server according to another embodiment of the present disclosure.

### MODE FOR INVENTION

The present disclosure may be changed in various ways and may have various embodiments. Specific embodiments are to be illustrated in the drawings and specifically described.

It should be understood that the present disclosure is not intended to be limited to the specific embodiments, but includes all of changes, equivalents and/or substitutions included in the spirit and technical range of the present disclosure.

Terms used in the present application are used to merely describe specific embodiments and are not intended to restrict the present disclosure. An expression of the singular number includes an expression of the plural number unless clearly defined otherwise in the context. In the present application, it is to be understood that a term, such as “include” or “have”, is intended to designate that a characteristic, a number, a step, an operation, a component, a part or a combination of them described in the specification is present, and does not exclude the presence or addition possibility of one or more other characteristics, numbers, steps, operations, components, parts, or combinations of them in advance.

All terms used herein, including technical terms or scientific terms, have the same meanings as those commonly understood by a person having ordinary knowledge in the art to which the present disclosure pertains, unless defined otherwise in the specification. Terms, such as those defined in commonly used dictionaries, should be construed as having the same meanings as those in the context of a related technology, and are not construed as ideal or excessively formal meanings unless explicitly defined otherwise in the specification.

Hereinafter, preferred embodiments of the present disclosure are more specifically described with reference to the accompanying drawings. In describing the present disclosure, in order to help general understanding, the same reference numerals are used to denote the same components throughout the drawings, and a redundant description of the same components is omitted.

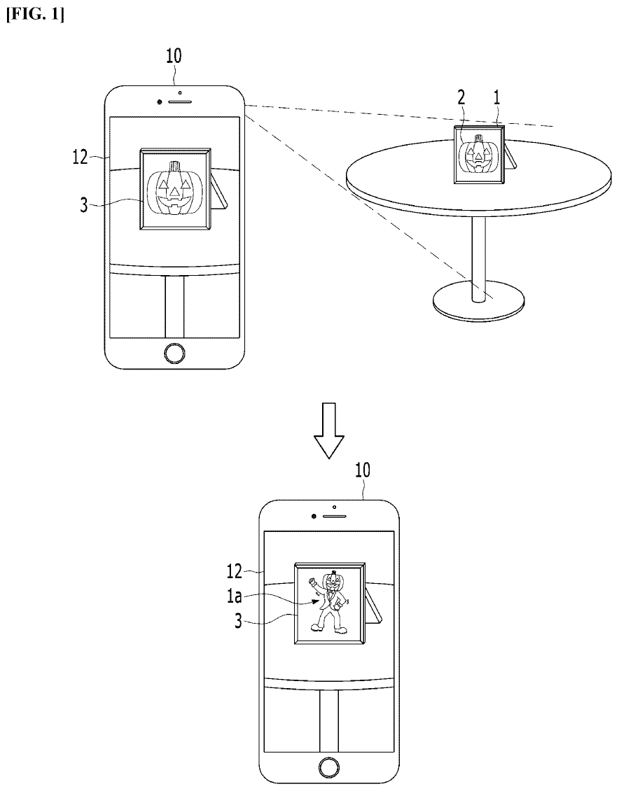

FIGS. 1 and 2 are diagrams for describing a basic concept of the present disclosure.

As illustrated in FIG. 1, first, a user drives an app by manipulating a mobile terminal 10 and then photographs a picture frame 1 on a table and surroundings thereof, for example. The picture frame 1 includes a photo of a Halloween pumpkin 2, that is, a still image, for example.

A form in which the picture frame 1 is placed on the table is displayed on a display 12 of the mobile terminal 10.

Furthermore, the mobile terminal 10 transmits the photographing image to a server. In this case, the photographing image is an image that is generally displayed on a front surface of the display 12 of the mobile terminal 10, and may include a part of the table and a picture frame image 3 in the case of FIG. 1.

Thereafter, the server selects a subject to be recognized in the received photographing image. The server will select the picture frame image 3 as the subject to be recognized by extracting the picture frame image 3 from the photographing image.

Furthermore, the server extracts a candidate image corresponding to the photo frame image 3, among candidate images stored therein.

Next, the server transmits a video (e.g., a video of a person who moves with a Halloween pumpkin with his or her head) associated with the extracted candidate image to the mobile terminal 10. In this case, the video is an example of image content. That is, the video has been transmitted to the mobile terminal 10 for convenience of description, but it may be understood that preferably, the server transmits image content associated with the extracted candidate image to the mobile terminal 10. Examples of the image content may include a still image, a video, text, etc.

Accordingly, a video 1a of a person who moves with a Halloween pumpkin on his or her head is played back on the display 12 of the mobile terminal 10. In this case, the video 1a may be played back for a short time. Furthermore, the video 1a is played back within an area of the picture frame image 3 that is displayed on the display 12. The video 1a may be displayed with augmented reality.

Although the user has inclined the picture frame leftward by a predetermined value by holding the picture frame by the hand as illustrated in FIG. 2, the video 1a may be played back within an area of the picture frame image 3 that is displayed on the display 12.

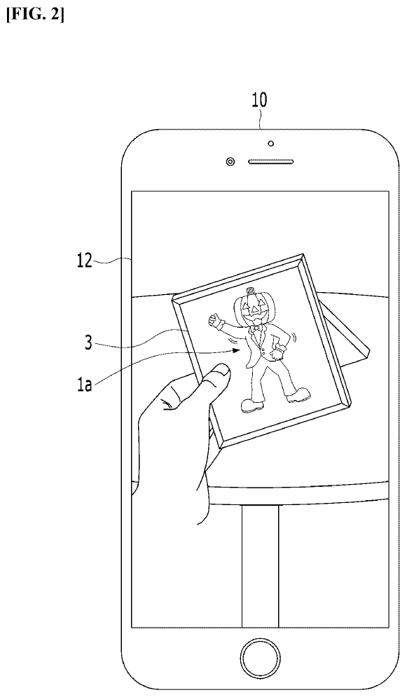

FIG. 3 is a diagram for describing a schematic operation of a system according to an embodiment of the present disclosure.

First, the mobile terminal 10 extracts a target image 9 from a photographed photographing image. In this case, the photographing image is an image that is obtained through an image sensor (not illustrated), and may mean an image that is displayed in the entire display area of the display 12. In the mobile terminal 10, one or more subjects for photography may be included in the photographing image because one subject for photography or several subjects for photography may be photographed at a time. The target image 9 may mean an image of an area in which a subject to be recognized within the photographing image is present. For example, a predetermined image A (still image), text, etc. that will become a recognition subject may be present in the area of the target image 9. Accordingly, the mobile terminal 10 detects an area (may be called an interested area) in which a predetermined image, text, etc. is present. An image of the corresponding area may be called a target image. A method of extracting a target image from a photographing image may be sufficiently understood by those skilled in the art through a known technology.

In the system of FIG. 3, the mobile terminal 10 may have a plurality of candidate images 5 embedded therein. The mobile terminal 10 extracts a subject image corresponding to the target image 9, among the plurality of candidate images 5 that has been previously stored.

In this case, each of the plurality of candidate images 5 may be one image, among a still image indicative of a still picture and a text image including letters. Furthermore, the target image 9 may be one image, among a still image indicative of a still picture and a text image including letters. Each of the plurality of candidate images 5 and the target image 9 may each be an image in which predetermined text is included in a still image, if necessary.

Furthermore, a method of extracting a subject image corresponding to the target image 9, among the plurality of candidate images 5, may be various. For example, there may be a method of extracting a subject image by comparing the entire area of the target image 9 and the entire area of each of the candidate image 5. As another example, there may be a method of extracting a subject image by comparing a feature point within the target image 9 and a feature point within each candidate image 5. As still another example, there may be a method of extracting a subject image by comparing text within the target image 9 and text within each candidate image 5 because text may be included in the candidate image 5 and the target image 9.

Accordingly, the mobile terminal 10 may extract a subject image by using any one method, among the exemplified three methods. A subject image may be extracted by combining a plurality of methods, among the exemplified three methods, if necessary.

Meanwhile, if a subject image corresponding to the target image 9, among the plurality of candidate images 5, can be extracted, another method other than the exemplified methods may be used.

As described above, if the target image 9 is extracted from the photographing image and a subject image corresponding to the target image 9 is extracted, it may be said that a photographing image has been recognized.

Thereafter, the mobile terminal 10 transmits the extracted subject image to a server 50. Preferably, the mobile terminal 10 may transmit the identifier of the extracted subject image to the server 50.

The server 50 previously stores a plurality of candidate images 6 and image content associated with each of the candidate images in a file form.

In this case, each of the plurality of candidate images 6 may be one image, among a still image indicative of a still picture and a text image including symbols (including signs, letters, marks, etc.). Each of the plurality of candidate images 6 may be an image in which predetermined text is included in a still image, if necessary.

Furthermore, the image content may be understood as a concept including both a still image indicative of a still picture, a moving image (video) including a plurality of still images, and a text image including symbols (may include signs, letters, marks, etc.).

In the following description of an embodiment of the present disclosure, it is assumed and described that the image content is a video (moving image).

According to the assumption, as illustrated in FIG. 3, the server 50 may previously store the plurality of candidate images 6 and videos 7 associated with each candidate image in a file form. In this case, the plurality of candidate images 6 of the server 50 includes the plurality of candidate images 5 of the mobile terminal 10. That is, it may be understood that the candidate image 5 stored in the mobile terminal 10 has been uploaded into the server 50.

Accordingly, the server 50 may easily search the plurality of candidate images 6 for a candidate image corresponding to a received subject image. The reason is that a candidate image having the same identifier as a received subject image is included in the plurality of candidate images 6 of the server 50.

Furthermore, the server 50 transmits a video Aa that is selected according to a predetermined rule or randomly, among a plurality of videos associated with a retrieved candidate image (i.e., a subject image), to the mobile terminal 10 so that the video Aa can be played back within an area of the target image 9 on the display 12 of the mobile terminal 10.

In this case, the predetermined rule may be a choice probability of each of the plurality of videos associated with the subject image. For example, the predetermined rule may be the choice probability of each video associated with a subject image as if the choice probability of a first video is determined as 40%, the choice probability of a second video is determined as 30%, the choice probability of a third video is determined as 20%, the choice probability of a fourth video is determined as 7%, and the choice probability of a fifth video is determined as 3% when the five videos are present in association with the subject image.

The predetermined rule may mean that videos are sequentially selected one by one each time. That is, the predetermined rule may mean that videos are sequentially selected one by one each time as if a first video is selected for the first time, a second video is selected for the second time, and a third video is selected for the third time with respect to the same subject image (i.e., the same photographing image).

The writing “randomly” may mean that videos are randomly selected regardless of the predetermined rule.

Accordingly, the mobile terminal 10 plays back the received video Aa within an area of the target image 9 on the display 12. In this case, the video Aa may be displayed with augmented reality.

According to FIG. 3, when the mobile terminal 10 recognizes the photographing image, the server 50 does not need to recognize an image.

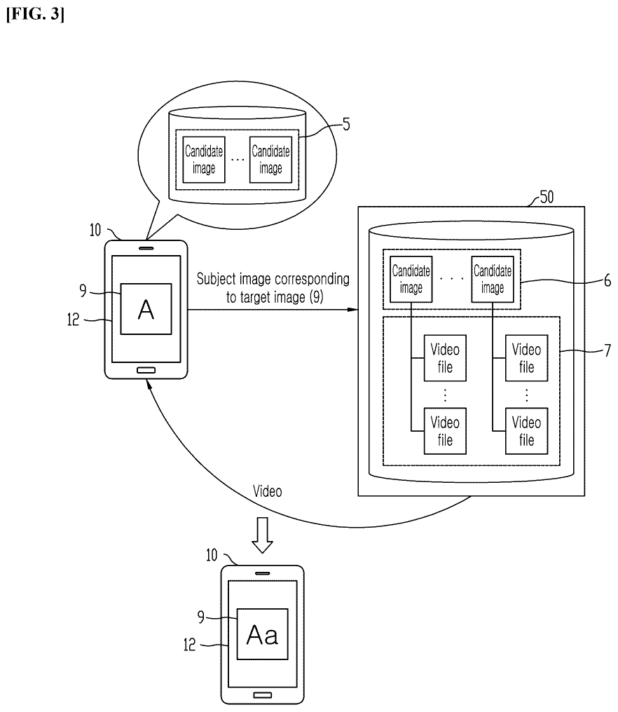

FIG. 4 is a diagram for describing a schematic operation of the system according to another embodiment of the present disclosure.

On the assumption that image content is a video (moving image), in the case of FIG. 4, the server 50 may previously store the plurality of candidate images 6 to be compared with a target image and each of the plurality of videos 7 (image content) associated with each candidate image in a file form.

First, the mobile terminal 10 extracts a target image 9 from a photographed photographing image (i.e., an image displayed in the entire display area of the display 12). As described above even in the case of FIG. 4, the target image 9 may mean an image of an area in which a subject to be recognized within the photographing image is present. For example, the target image 9 may mean an image of an area which may be called an interested area within the photographing image.

Thereafter, the mobile terminal 10 transmits the extracted target image 9 to the server 50.

The server 50 extracts a subject image corresponding to the target image 9, among the plurality of candidate images 6 that has been previously stored. The target image 9 may be said to be an image the range of which to be recognized has been reduced compared to the photographing image. That is, the server 50 extracts the subject image based on the target image 9 not the photographing image, and thus can extract the subject image more rapidly compared to a case in which the subject image is extracted from the photographing image.

In this case, a method of extracting the subject image corresponding to the target image 9, among the plurality of candidate images 6, may be the same as the method of extracting the subject image in the mobile terminal 10.

The server 50 selects one video, among a plurality of videos associated with a subject image, among the candidate images, according to a predetermined rule because the plurality of videos is associated with the extracted subject image (i.e., the candidate image), and transmits the selected video to the mobile terminal 10 so that the selected video can be played back within an area of the target image 9 on the display 12 of the mobile terminal 10.

Accordingly, the mobile terminal 10 plays back the received video Aa within the area of the target image 9 on the display 12. The video Aa may be displayed with augmented reality.

The server 50 may transmit, to the mobile terminal 10, the video selected as described above so that the video overlays at least some area of the photographing image on the display of the mobile terminal 10, if necessary. Accordingly, the mobile terminal 10 may play back the received video so that the received video overlays the at least some area of the photographing image on the display.

According to FIG. 4, the mobile terminal 10 provides a target image within a photographing image to the server 50, and the server 50 extracts a subject image based on the target image. Accordingly, the subject image can be extracted more rapidly compared to a case in which the subject image is extracted from the photographing image.

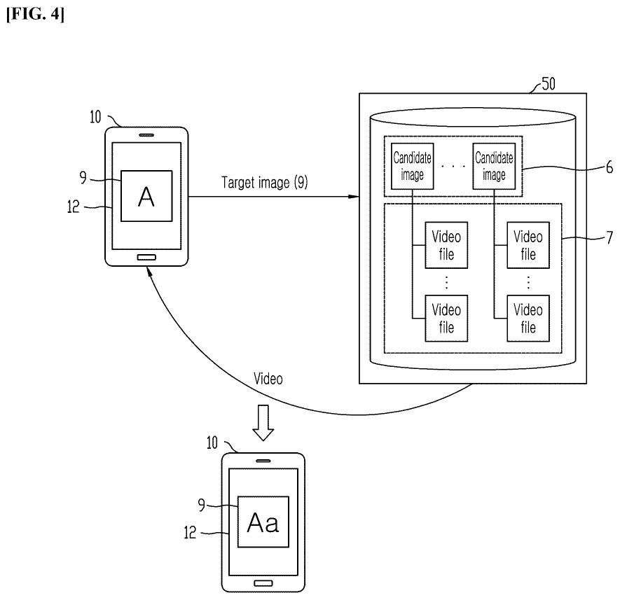

FIG. 5 is a construction diagram of the entire system according to an embodiment of the present disclosure.

The system of FIG. 5 may include the mobile terminal 10, a network 20, and the server 50.

The mobile terminal 10 may store or not store a plurality of candidate images.

For example, the mobile terminal 10 may photograph a video, and may select a representative frame automatically or manually, among the frames of the photographed video. The mobile terminal 10 may upload the representative frame into the server 50 by associating a candidate image (i.e., a representative image) with a corresponding video by using the representative frame as the candidate image.

When associating the candidate image (i.e., the representative image) and the video, the mobile terminal 10 may associate a plurality of videos with one candidate image.

The mobile terminal 10 uploads the candidate image (i.e., the representative image) and the plurality of videos that are associated with each other into the server 50, and may store a generated candidate image (i.e., the representative image) in memory therein. That is, the mobile terminal stores candidate images if the candidate images need to be stored.

If necessary, a representative image is not selected from a photographed video but an image different from a corresponding video may be selected as the representative image. For example, a menu image may be selected as a representative image. If three food menus are present and a video of each of the food menus has been photographed, representative images of the videos need to become menu images. Accordingly, a video and menu image of the food menu may be associated.

Meanwhile, the mobile terminal 10 may use a stored video or a received video without photographing a video.

Furthermore, the mobile terminal 10 may print a stored candidate image (i.e., a representative image) through a printer.

FIG. 5 has illustrated only one mobile terminal 10, but it may be understood that multiple mobile terminals 10 are practically present. Accordingly, each mobile terminal 10 may upload a candidate image (i.e., a representative image) and a video that have been associated into the server 50.

First, a case in which a plurality of candidate images has been stored in the mobile terminal 10 is described. In this case, it is assumed that candidate images from each mobile terminal 10 and a plurality of videos associated with each candidate image have been stored in the server 50.

In this case, the mobile terminal 10 may extract a target image from a photographing image captured by a camera, and may extract a subject image corresponding to the target image, among candidate images. The mobile terminal 10 may transmit the extracted subject image (preferably, the identifier of the subject image) to the server 50, and may then receive a video that is selected according to a predetermined rule or randomly, among a plurality of videos associated with the subject image, from the server 50. That is, the server 50 may transmit a video that is selected according to a predetermined rule or randomly, among a plurality of videos associated with the subject image, to the mobile terminal 10 so that the video can be played back within an area of a target image on the display of the mobile terminal 10. Accordingly, the mobile terminal 10 may play back the received video within the area of the target image on the display. In this case, the video may be displayed with augmented reality. On the one hand, if necessary, the server 50 may transmit the video selected as described above to the mobile terminal 10 so that the video overlays at least some area of the photographing image on the display of the mobile terminal 10. Accordingly, the mobile terminal 10 may play back the received video so that the received video overlays the at least some area of the photographing image on the display.

When transmitting the subject image to the server 50, the mobile terminal 10 may also transmit the user account of the corresponding mobile terminal, if necessary. This may be necessary for the management of transmission records for each user account on the side of the server 50.

A case in which a plurality of candidate images is not stored in the mobile terminal 10 is described below. In this case, it is assumed that candidate images from each mobile terminal 10 and a plurality of videos associated with each candidate image have been stored in the server 50.

In this case, the mobile terminal 10 extracts a target image from a photographing image captured by the camera. The mobile terminal 10 may transmit the extracted target image to the server 50. Accordingly, the server 50 extracts a subject image corresponding to the target image, among candidate images. Furthermore, the server 50 may transmit a video that is selected according to a predetermined rule or randomly, among a plurality of videos associated with the extracted subject image, to the mobile terminal 10 so that the video can be played back within an area of a target image on the display of the mobile terminal 10. Accordingly, the mobile terminal 10 may play back the received video within the area of the target image on the display. In this case, the video may be displayed with augmented reality. On the one hand, if necessary, the server 50 may transmit the video selected as described above to the mobile terminal 10 so that the video overlays at least some area of the photographing image on the display of the mobile terminal 10. Accordingly, the mobile terminal 10 may play back the received video so that the received video overlays the at least some area of the photographing image on the display.

When transmitting the target image to the server 50, the mobile terminal 10 may also transmit the user account of the corresponding mobile terminal. This may be necessary for the management of transmission records for each user account on the side of the server 50. Furthermore, the server 50 can extract a subject image corresponding to a target image, among candidate images, more rapidly compared to a case in which the target image is compared with all of the candidate images because the server has only to compare the target image with only the candidate images of the user account of a corresponding mobile terminal.

Meanwhile, in FIG. 5, the mobile terminal 10 may be implemented with an electronic device capable of accessing the server 50 over a network 20. For example, the mobile terminal 10 is a wireless communication device for which portability and mobility are guaranteed, for example, and may include all types of handheld-based wireless communication devices, such as a personal communication system (PCS), a global system for mobile communications (GSM), personal digital cellular (PDC), a personal handyphone system (PHS), a personal digital assistant (PDA), International Mobile Telecommunication (IMT)-2000, code division multiple access (CDMA)-2000, w-code division multiple access (W-CDMA), a wireless broadband Internet (WiBro) terminal, a smartphone, a smartpad, and a tablet PC.

The network 20 may mean a connection structure in which nodes, such as the mobile terminal 10 and the server 50, may exchange information.

For example, the network 20 using a wireless communication method may include a wireless LAN (WLAN), wireless broadband (WiBro), wideband CDMA (WCDMA), IEEE 802.16, long term evolution (LTE), long term evolution-advanced (LTE-A), Bluetooth, radio frequency identification (RFID), infrared data association (IrDA), ultra-wideband (UWB), ZigBee, near field communication (NFC), ultra sound communication (USC), visible light communication (VLC), and Wi-Fi, but the present disclosure is not limited thereto.

Meanwhile, the network 20 using a wired communication method may include a wired local area network (LAN), a wired wide area network (WAN), power line communication (PLC), USB communication, Ethernet, serial communication, optical/coaxial cable communication, etc., but the present disclosure is not limited thereto.

In FIG. 5, the server 50 may include an image server 30 and a video server 40.

In this case, the image server 30 may store and manage a plurality of candidate images. The plurality of candidate images within the image server 30 may be updated, if necessary.

The image server 30 may receive a target image extracted from a photographing image from the mobile terminal 10, and may extract a subject image corresponding to the target image, among the plurality of candidate images.

If the mobile terminal 10 transmits the target image to the server 50, the server 50 may require the image server 30. If the mobile terminal 10 transmits the identifier of the subject image to the server 50, the server 50 may not require the image server 30.

The video server 40 may store and manage a plurality of videos associated with each of the candidate images. The plurality of videos associated with each of the candidate images within the video server 40 may be updated, if necessary.

The video server 40 may select one video according to a predetermined rule or randomly, among the plurality of videos associated with the subject image extracted by the image server 30, and may transmit the selected video to the mobile terminal 10 so that the selected video can be played back within an area of a target image on the display of the mobile terminal 10. In this case, the predetermined rule may be the choice probability of each of the plurality of videos associated with the subject image as described above. The predetermined rule may mean that videos are sequentially selected one by one each time. The writing “randomly” may mean that videos are randomly selected regardless of the predetermined rule.

On the one hand, the video server 40 may transmit a video that is selected according to a predetermined rule or randomly to the mobile terminal 10 so that the video overlays at least some area of the photographing image on the display of the mobile terminal 10 as described above.

The video server 40 may receive a subject image (preferably, the identifier of the subject image) from the mobile terminal 10.

The video managed by the video server 40 is an example of image content as described above. More broadly, the video server 40 may be called an image content server.

If necessary, the video server 40 may not be required for the server 50. For example, although a video is not stored in the server 50, the video may be streamed through an external link, such as the YouTube link.

It has been described that the image server 30 receives the target image from the mobile terminal 10. However, the image server 30 may receive the photographing image from the mobile terminal 10, if necessary. The extraction of the target image from the photographing image by the image server 30 has only to be performed identically with a method of extracting target image in the mobile terminal 10. Accordingly, the image server 30 may receive the photographing image from the mobile terminal 10.

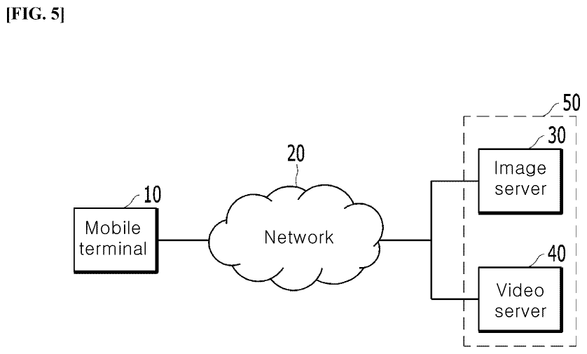

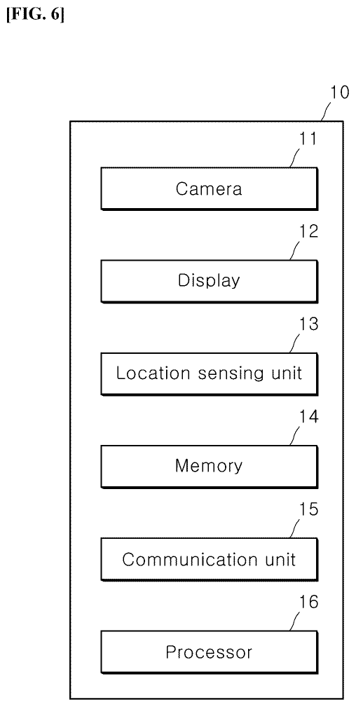

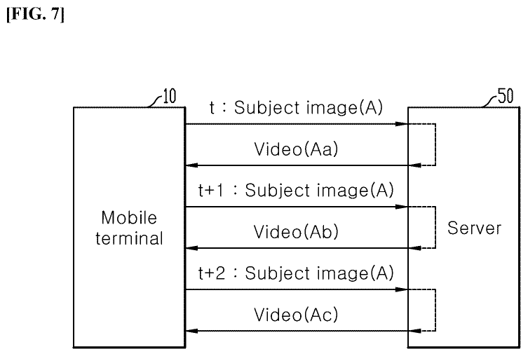

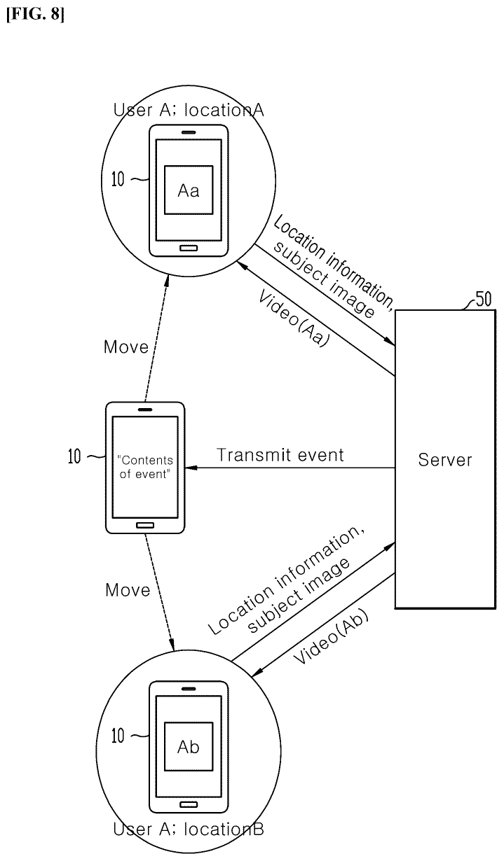

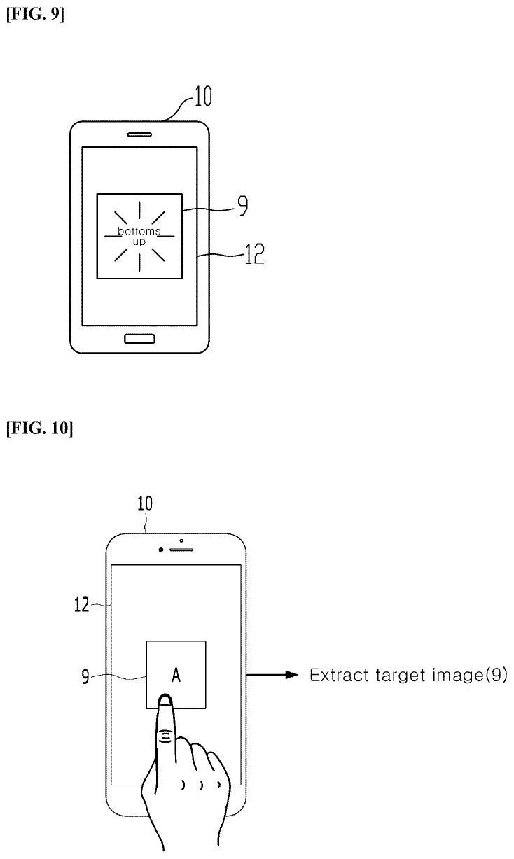

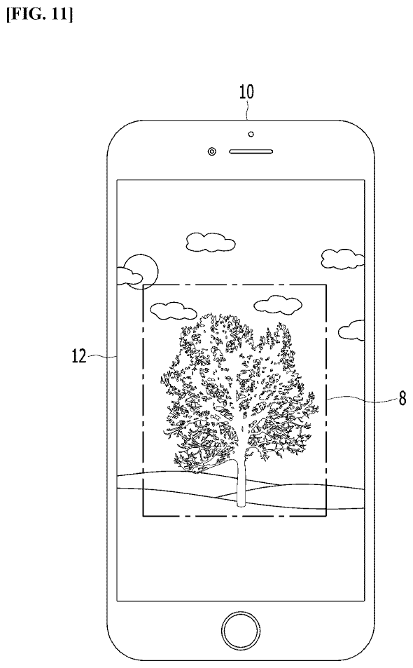

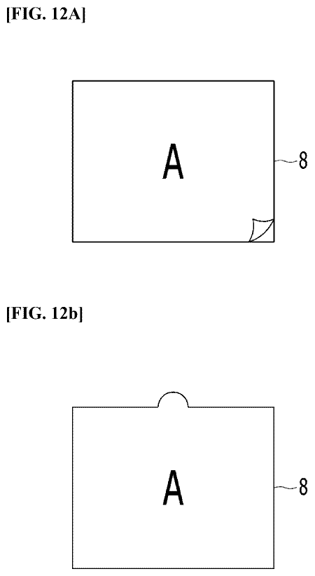

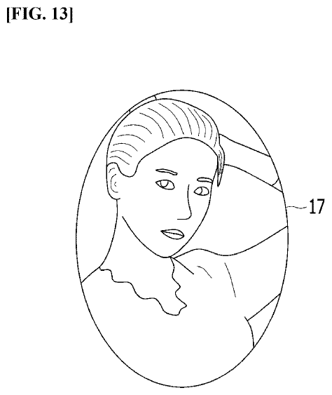

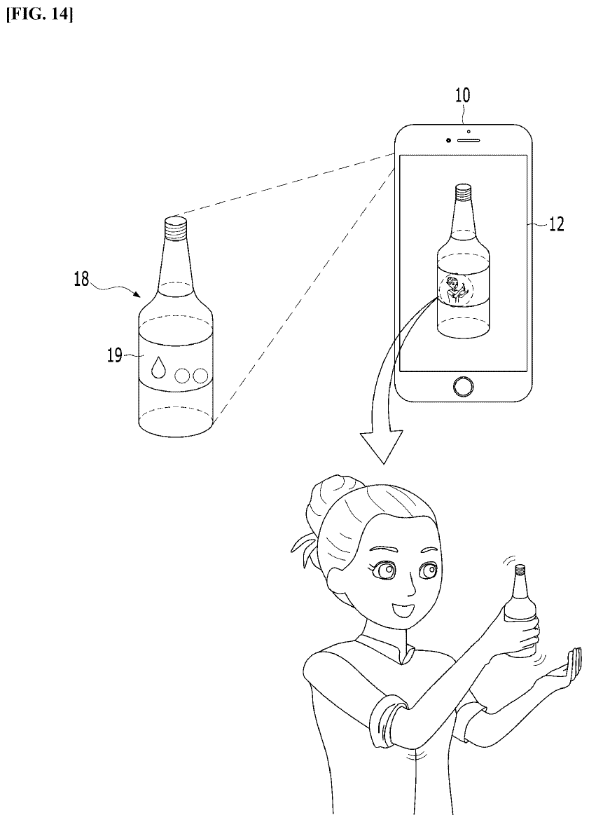

FIG. 6 is an internal construction diagram of the mobile terminal illustrated in FIG. 5. FIG. 7 is a diagram that is adopted to describe that the videos of the same subject image that is received over time are different in a mobile terminal. FIG. 8 is a diagram that is adopted to describe a case in which the mobile terminal receives videos at several locations while operating in conjunction with the locations. FIG. 9 is a diagram that is adopted to describe a case in which the mobile terminal receives indication contents from a server. FIG. 10 is a diagram that is adopted to describe a case in which the mobile terminal illustrated in FIG. 5 receives an extraction command from a user. FIG. 11 is a diagram that is adopted to describe the extraction of a target image when an edge pattern is present in a photographing image. FIGS. 12A and 12B are diagrams illustrating another example of an edge pattern. FIG. 13 is a diagram that is adopted to describe a case in which the outer trajectory of a target image is not a quadrangle. FIG. 14 is a diagram that is adopted to describe an example of a case in which a target image is attached to a curved surface object.

In FIG. 6, the mobile terminal 10 may include a camera 11, the display 12, a location sensing unit 13, memory 14, a communication unit 15, and a processor 16.

The camera 11 may photograph an external arbitrary object (e.g., a photo, a product label, an advertising image of a bus station shelter, a movie, a concert poster, a book, a liquor bottle, a milk carton, and a gift box) and surroundings thereof. An image captured by the camera 11 may be displayed on the display 12. In this case, the external arbitrary object may be said to be a subject for photography.

The camera 11 may include an image sensor.

The display 12 may display an image captured by the camera 11.

A touch screen may be installed on a front surface of the display 12. Accordingly, the display 12 may detect a user touch input and provide the user touch input to the processor 16.

The location sensing unit 13 may sense the location of a corresponding mobile terminal 10.

The memory 14 may store a plurality of candidate images. In this case, the plurality of candidate images is images that are compared with a target image, and may be said to be recognition data.

The memory 14 may include a fixed data block and a temporary data block.

Data that need to be fixed and stored, like a photo and a video, may be stored in the fixed data block. For example, candidate images associated with a physical object, such as a book, may be stored in the fixed data block because a thing, such as a book, is read for a long time.

Candidate images associated with location information for each zone may be stored in the temporary data block. For example, when the mobile terminal 10 is placed in a specific zone and an app is driven, candidate images associated with information on the location the corresponding specific zone may be downloaded and stored in the temporary data block. Accordingly, when determining that a current location of a corresponding mobile terminal 10 falls outside the location of information location associated with candidate images stored in the temporary data block, the processor 16 may delete the candidate images associated with the corresponding location information, which have been stored in the temporary data block.

Furthermore, in the case of the temporary data block, long data may be deleted according to a first-in first-out (FIFO) method.

The memory 14 may store a program including instructions for performing a series of operation that are performed by the mobile terminal 10.

The communication unit 15may perform communication with the server 50.

The processor 16 may control an overall operation of the mobile terminal 10.

The processor 16 may mean a device capable of performing a series of operations or determinations for an operation of the mobile terminal 10. For example, the processor 16 may be a central processing unit (CPU), a micro controller unit (MCU), a graphical processing unit (GPU), an application specific integrated circuit (ASIC), or a field programmable gate array (FPGA), but the present disclosure is not limited thereto.

The processor 16 may store one or more instructions in memory that is internally provided, and may perform control so that the aforementioned operations are performed by executing the one or more instructions stored in the memory that is internally provided. That is, the processor 16 may perform a function of the mobile terminal 10 by executing at least one instruction or program stored in the internal memory provided within the processor 16 or the memory 14. In this case, the memory 14 may store one or more instructions executable by the processor 16.

First, control operations of the processor 16 in a case in which candidate images are stored in the memory 14 are described.

The processor 16 may extract a target image from a photographing image captured by the camera 11, and may extract a subject image corresponding to the target image, among candidate images. When the subject image is extracted as described above, it may be said that the corresponding subject image has be recognized. The processor 16 transmits the extracted subject image (preferably, the identifier of the subject image) to the server 50 through the communication unit 15.

The processor 16 may receive a video associated with the extracted subject image from the server 50 through the communication unit 15. That is, in this case, the video means one video that is selected according to a predetermined rule or randomly, among a plurality of videos associated with the extracted subject image. In this case, the predetermined rule may be the choice probability of each of the plurality of videos associated with the subject image as described above. The predetermined rule may mean that videos are sequentially selected one by one each time. The writing “randomly” may mean that videos are randomly selected regardless of a predetermined rule. Furthermore, the video might have been transmitted by the server 50 so that the video can be played back within an area of a target image on the display 12 of the mobile terminal 10. Accordingly, the processor 16 may play back the received video within the area of the target image on the display 12. For example, the processor 16 may play back the video with augmented reality.

In this case, it is preferred that a current video that is received by the processor 16 through the communication unit 15 is different from a video that was received before with respect to the same subject image when the current video is a video that is received with respect to the same subject image. For example, this means that as illustrated in FIG. 7, if the processor 16 of the mobile terminal 10 has received the video Aa by transmitting the subject image A to the server 50 at a predetermined time (e.g., t), when the processor transmits the same subject image A to the server 50 at a subsequent time (e.g., t+1), the processor receives a video Ab different from a video that was received before. According to the description of FIG. 7, a user can feel interest because several videos can be played back according to a predetermined rule or randomly and consecutively with respect to one image (e.g., a movie poster).

Meanwhile, the processor 16 may receive videos at several locations while operating in conjunction with the location of the mobile terminal 10. For example, as illustrated in FIG. 8, the mobile terminal 10 of a user A receives predetermined event information (e.g., including contents reading “please participate in an event in which a participant drinks 00Soju in a zone No. 1 (location A) of Seoul and a zone No. 2 (location B) of Seoul”) from the server 50. Thereafter, the user A checks the event information and then moves to the zone No. 1 (location A) and the No. 2 zone (location B) in order to participate in the event. First, when moving to the zone No. 1 (location A), the user A drinks the 00Soju, then photographs the label of the 00Soju, and transmits information on the current location of a corresponding mobile terminal 10 to the server 50 along with an extracted subject image. Thereafter, the server 50 transmits the video Aa selected according to a predetermined rule or randomly, among a plurality of videos associated with the received subject image, so that the video Aa can be played back within an area of a target image on the display of the mobile terminal 10 of the user A. Accordingly, the mobile terminal 10 of the user A in the zone No. 1 (location A) plays back the received video Aa within the area of the target image on the display. Thereafter, the user A moves to the zone No. 2 (location B), drinks the 00Soju, then photographs the label of the 00Soju, and transmits information on the current location of a corresponding mobile terminal 10 to the server 50 along with the extracted subject image. Thereafter, the mobile terminal 10 of the user A of the zone No. 2 (location B) receive the video Ab that is selected according to a predetermined rule or randomly, among a plurality of videos associated with the subject image, from the server 50, and plays back the received video Ab within an area of a target image on the display of the mobile terminal 10 of the user A.

In this case, the processor 16 can collect different videos at several locations while operating in conjunction with locations according to the contents of an event.

Meanwhile, to select a video according to a predetermined rule or randomly and play back the video as described above may also be served and used even in a drinking game. For example, a user (hereinafter called a “penalty performer”) who needs to perform a penalty by performing a predetermined drinking game may be determined. Thereafter, a determined corresponding user photograph a label on a liquor bottle and transmits an extracted subject image (preferably, the identifier of the subject image) to the server 50. The server 50 transmits a video that is selected according to a predetermined rule or randomly, among a plurality of videos associated with the received subject image, so that the video can be played back within an area of a target image on the display of the mobile terminal 10 of the corresponding penalty performer. In this case, the selected video includes indication contents for the corresponding penalty performer. Accordingly, the mobile terminal 10 of the penalty performer plays back the received video within the area of the target image on the display. Accordingly, a video (e.g., including indication contents “bottoms up”), such as that exemplified in FIG. 9, may be displayed within the area of the target image on the display of the mobile terminal 10. Although only the bottoms up is simply displayed in FIG. 9, a video of a cheerleader who moves rhythmically may be displayed along with the indication contents of the bottoms up. Thereafter, the penalty performer performs a penalty after watching the video (e.g., including the indication contents “bottoms up”) on the display of the mobile terminal 10.

Examples of the indication contents may be various, such as a love shot with a left person, a king game, and bottoms up if there's even a little bit of red on what you're wearing or wearing, in addition to the bottoms up. Accordingly, the video received by the processor 16 through the communication unit 15 may include predetermined indication contents for the user.

In contrast, to select a video according to a predetermined rule or randomly and play back the video as described above may also be used when a coupon is provided in addition to the drinking game. In this case, the provision of the coupon means that a coupon that is selected according to a predetermined rule or randomly is provided. Accordingly, the video that is received by the processor 16 through the communication unit 15 may include predetermined coupon content.

The aforementioned drinking game service and random coupon service may be parts of a draw event.

On the one hand, it has been described that the processor 16 plays back a video received from the server 50 within an area of a target image on the display 12. However, a video received from the server 50 may be played back so that the received video overlays at least some area of a photographing image on the display 12, if necessary.

Meanwhile, in FIG. 6, when receiving an extraction command (e.g., a touch input; refer to FIG. 10) from a user, the processor 16 may operate to perform the extraction of a target image 9 of a current photographing image. In this case, the photographing image may mean an image (i.e., including an image different from the target image 9) that is displayed on the entire front surface of the display 12. The target image 9 may mean that an image of an area in which a subject to be recognized within the photographing image is present. For example, the target image 9 may mean an image of an area which may be called an interested area within the photographing image.

If target images for all of images that are continuously captured by the camera 11 have to be extracted, a load in the mobile terminal 10 will be inevitably increased. However, if the extraction of a target image for a current photographing image is performed only when an extraction command, such as a touch input, is received as described above, a load in the mobile terminal 10 can be significantly reduced because the unnecessary extraction of the target image is prevented.

A specific code, such as a QR code, may be used instead of a touch input, if necessary. That is, when a user photographs an area in which a QR code is present in a photo, a movie poster, etc. and surrounding areas thereof, the QR code may be displayed on the display 12. Accordingly, when recognizing the QR code within a current photographing image, the processor 16 may operate to perform the extraction of the target image 9 for the current photographing image.

If a subject image corresponding to a target image, among candidate images stored in the memory 14, cannot be extracted, the processor 16 may request the server 50 to extract the subject image through the communication unit 15. The reason for this is that if there is some degree of damage to a subject image corresponding to a target image, the subject image may not be properly extracted.

The processor 16 may extract the target image by detecting a predetermined edge pattern. As illustrated in FIG. 11, the processor 16 may search a photographing image (i.e., an image displayed on the entire front surface of the display 12) for a predetermined edge pattern 8, may determine an area surrounded by the edge pattern 8 as an area of a target image, and may extract an image within the determined area as the target image.

For example, a photographing image displayed on the display 12 of FIG. 11 may be said to be an image that appears when a user photographs a movie poster. The edge pattern 8 having a quadrangle indicated by an alternate long and short dash line may be previously printed on the corresponding movie poster. In this case, the edge pattern 8 may be designated by a production company that produces the corresponding movie poster or on the client side that requests the production of the movie poster.

As described above, the edge pattern 8 may help to extract a target image more rapidly. If the edge pattern 8 is present compared to a case in which the edge pattern 8 is not present, the time required to search the photographing image for the target image can be reduced.

In an embodiment of the present disclosure, the edge pattern 8 is not limited to a rectangular shape indicated by the alternate long and short dash line, which is exemplified in FIG. 11, and may be shapes, such as those exemplified in FIGS. 12A and 12B. The edge pattern 8 may be a shape other than the shapes exemplified in FIGS. 11, 12A, and 12B, if necessary.

Meanwhile, the processor 16 may select a representative frame, among the frames of a video photographed by the camera 11, and may upload the representative frame (i.e., a representative image) into the server 50 by associating the representative frame with the corresponding video by using the representative frame as a candidate image. If necessary, the processor 16 does not select the representative image from the photographed corresponding video, but may select an image different from the corresponding video as the representative image. Accordingly, the processor 16 may insert a specific edge pattern into a candidate image that is obtained by photographing a book, a product label, a photo, a movie poster, a concert poster, company introduction, etc. depending on its use. Furthermore, the processor 16 may upload the candidate image into which the specific edge pattern has been inserted and a video including a description thereof into the server 50 by associating the candidate image and the video.

Accordingly, candidate images stored in the memory 14 may be stored in association with one of a plurality of edge patterns. For example, assuming that three edge patterns that are different from each other are present, a first edge pattern may be associated with (e.g., inserted into) a first candidate image (e.g., an image including a label on a liquor bottle). A second edge pattern may be associated with (e.g., inserted into) a second candidate image (e.g., a movie poster). A third edge pattern may be associated with (e.g., inserted into) a third candidate image (e.g., an image of the cover of a book). If candidate images are stored in association with one of a plurality of edge patterns as described above, a subject image can be extracted more rapidly because the subject image corresponding to a target image, only among the candidate images associated with a corresponding specific edge pattern, has only to be extracted not a comparison with all of the candidate images. Furthermore, a user can easily obtain a video to be collected by photographing only a photographing subject including an edge pattern that the user wants.

Meanwhile, the candidate images of the memory 14 may be stored in association with location information. In this case, the location information may mean information on the location of a zone. For example, first to third candidate images may be associated with location information that means a first zone. A fourth candidate image to a tenth candidate image may be associated with location information that means a second zone. If candidate images are stored in association with location information as described above, the processor 16 can extract a subject image corresponding to a target image, among candidate images associated with information on a location near the current location of the mobile terminal 10. For example, if a current location sensed by the location sensing unit 13 of the mobile terminal 10 corresponds to information on the location of the first zone, the processor 16 extracts a subject image corresponding to a target image, among the first to third candidate images associated with the information on the location of the first zone. The reason for this is that the subject image corresponding to the target image can be searched for more rapidly. That is, if candidate images are stored in association with location information that means a zone, the processor 16 can extract a subject image corresponding to a target image through only a comparison between information on a location near the current location of the mobile terminal 10 and candidate images associated with not a comparison with all of the candidate images. Accordingly, the subject image can be extracted more rapidly.

If necessary, the processor 16 may transmit information on the current location of a corresponding mobile terminal 10 to the server 50, may receive candidate images associated with information on a location near the current location from the server 50, and may store the candidate images in the memory 14. In such a case, the storage capacity of the memory 14 can be minimized, and desired candidate images can be downloaded and used only when the candidate images are necessary.

On the one hand, if three museums are present in a specific zone and the current location of the mobile terminal 10 corresponds to the location of a first museum within the corresponding specific zone, it will be preferred that only candidate images allocated to the first museum are compared. If necessary, when selecting the first museum, among the three museums, a user can download only the candidate images allocated to the first museum from the server 50 and use the candidate images.

The candidate images of the memory 14 may be stored in association with time information. In this case, the processor 16 may extract a subject image corresponding to a target image, among candidate images associated with time information to which the current time of a corresponding mobile terminal 10 belongs. For example, this is for allowing a video associated with a subject image to be played back only during the time when a museum is open. That is, if the video which can be played back only during the time when the museum is open has been stored, the processor 16 may extract a subject image corresponding to a target image, among candidate images associated with corresponding time information, when the mobile terminal 10 approaches the museum or enters the museum during the time when the museum is open. Accordingly, the processor 16 may receive a video that is selected according to a predetermined rule or randomly, among a plurality of videos associated with the extracted subject image, from the server 50 during the time when the museum is open, may play back the video within an area of a target image on the display 12, or may play back the video so that the video overlays at least some area of a photographing image on the display 12. For example, the processor 16 may play back the video with augmented reality.

In FIG. 6, the processor 16 plays back a video within an area of a target image having a quadrangle, which is disposed in a plane shape. In some cases, as illustrated in FIG. 13, the outer trajectory of a target image 17 may not have a quadrangle. In FIG. 13, the outer trajectory of the target image 17 has been exemplified as an oval, but may have a shape other than a quadrangle and an oval. Even in such a case, for the playback of a video within a desired area, the processor 16 detects the outer trajectory of the target image 17. Furthermore, the processor 16 may play back a video within the detected outer trajectory 17 having the oval. For example, the processor 16 may play back the video with augmented reality.

The detection of the outer trajectory having the oval may be used when an extracted target image corresponds to a part of a candidate image having an outer trajectory having a quadrangle.

Meanwhile, the processor 16 may extract a subject image when a target image is disposed in a curved surface of a curved surface object. For example, as illustrated in FIG. 14, when a curved surface object 18, such as a liquor bottle, is captured by the camera of the mobile terminal 10, the corresponding curved surface object 18 may be displayed on the display 12 of the mobile terminal 10 as a photographing image. In this case, the curved surface object 18 may be a subject for photography. If another subject for photography is also present around the curved surface object 18, another subject for photography may also be captured and displayed on the display 12. In FIG. 14, it is assumed that only one curved surface object 18 is captured. In this case, when determining that a target image 19 (e.g., may include a product name, a logo, etc. as an image disposed in the curved surface object 18) has been disposed in the curved surface of the curved surface object 18, such as a liquor bottle, the processor 16 may complanate (correct) the corresponding target image based on curved surface information (e.g., including curvature), and may extract a corresponding subject image from a plurality of candidate images previously stored in the memory 14. In this case, the processor 16 may complanate (correct) the corresponding target image based on the curved surface information because the processor can sufficiently calculate the curvature of the target image. The reason why the complanation is performed is that to extract the subject image in a plane state may be more accurate. The aforementioned curved surface information may be a value that has been digitized by calculating the curved surface of the corresponding target image or may be information that complies with a degree of bending (e.g., a curvature value) of the curved surface of the corresponding target image 19, among a plurality of pieces of curved surface information that has been previously stored. Such curved surface information may be previously stored in the memory 14 for each candidate image.

On the one hand, the processor 16 may receive candidate images associated with a corresponding physical object from the server 50 in response to a candidate image request command for the physical object, such as a book, and may store the candidate images in the memory 14 by associating the physical object and the candidate images. In this case, the book may be a math workbook, a cookbook, a knitting book, an encyclopedia, etc. The physical object may include a museum, an exhibit hall, etc. in addition to the book. For example, the processor may download the body or an image (mathematical problem) of a book as a candidate image, and may store a corresponding physical object and the downloaded candidate image in the memory 14 by associating the corresponding physical object and the downloaded candidate image. In such a case, if the mobile terminal 10 has photographed the book, the processor 16 extracts a target image from a photographing image, and extracts a subject image corresponding to the target image, among candidate images, within the memory 14. Thereafter, the processor 16 may receive a video that is selected according to a predetermined rule or randomly, among a plurality of videos (e.g., explanation) associated with the extracted subject image, from the server 50, and may play back the video within an area of the target image on the display 12. For example, the processor 16 may play back the video with augmented reality.

FIG. 14 exemplifies that a video is played back within an area of a target image on the display 12. It may be slightly difficult or inaccurate to accurately play back a video within a label area (i.e., an area of the target image 19; a curved surface part) having predetermined curvature in the state in which a label has been disposed in a curved surface part of the curved surface object 18, such as a liquor bottle (e.g., a Soju bottle). For example, it may be difficult or inaccurate to play back a video accurately within a target image area whenever the mobile terminal because the location of the outer trajectory of a corresponding target image within a photographing image is different whenever the mobile terminal toward the curved surface object 18 is moved.

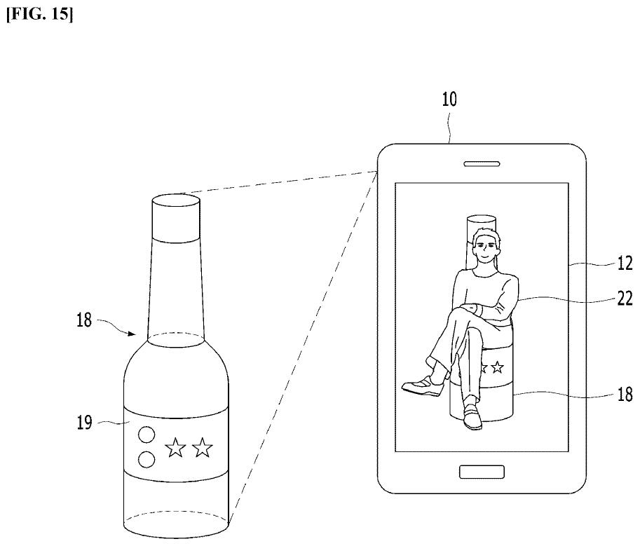

Accordingly, as illustrated in FIG. 15, the playback area of a video (an example of image content) may be enlarged as at least some area of a photographing image on the display 12.

First, as illustrated in FIG. 15, the mobile terminal 10 captures a curved surface object 18 (may be said to be a subject for photography and may be a Soju bottle, for example) and a target image 19 (e.g., may include a product name, a logo, etc. as a label image) disposed on a curved surface of the corresponding curved surface object 18. Accordingly, the processor 16 of the mobile terminal 10 extracts the target image (e.g., may include a product name, a logo, etc. as a label image) disposed on the curved surface of the curved surface object 18 from a photographing image on the display 12. In this case, the processor 16 of the mobile terminal 10 may extract an image of a label image area including a product name, a logo, etc. as the target image because the processor may consider the product name, the logo, etc. as a recognized subject. Next, the processor 16 extracts a subject image corresponding to the target image, among candidate images within the memory 14. Thereafter, the processor 16 transmits the identifier of the extracted subject image to the server 50, and receives image content that is selected according to a predetermined rule or randomly, among a plurality of pieces of image content (e.g., a still image, a video, and text) associated with the subject image, from the server 50. Next, the processor 16 may play back the received image content so that the received image content overlays at least some area of the photographing image on the display 12. For example, when playing back the image content, the processor 16 may make an object (e.g., a person) (a three-dimensional object) based on the image content stick out (pop up) to the front of the curved surface object 18 on one side (e.g., an upper side) of the curved surface object 18 on the display 12. Furthermore, the processor 16 may make a popped-up object 22 (e.g., a person) (a three-dimensional object) take a posture in which the popped-up object sits on a chair with one leg placed on the other leg in front of the curved surface object 18 on the display 12 as illustrated in FIG. 15. The processor 16 may adopt another posture (e.g., a standing posture) not the posture such as FIG. 15. In other words, the processor 16 plays back the image content associated with the extracted subject image so that the image content overlays at least some area of the photographing image on the display 12, but may play back the image content so that the image content is played back on the display 12 in the state in which the outer trajectory of the image content has not been matched with the outer trajectory of the target image. For example, an area occupied by the played-back image content may be wider or narrower than the area of the target image of the curved surface object 18 within the photographing image on the display 12. Meanwhile, the area occupied by the played-back image content may be wider or narrower than an area occupied by the curved surface object 18 in which the corresponding target image has been disposed within the photographing image. As illustrated in FIG. 15, a part of the curved surface object 18 on the display 12 may be made visible because the object 22 (the three-dimensional object) based on the image content is sitting with his or her legs crossed. As described above, the processor 16 may play back the image content so that the image content overlays at least some area of the target image on the display 12. The object 22 according to the image content exemplified in FIG. 15 may describe various types of information related to the corresponding curved surface object 18. Furthermore, the image content associated with the subject image may include gift content. When the description of the corresponding curved surface object 18 is finished by the object 22 by the video, as illustrated in FIG. 16, the processor 16 may play back predetermined gift content 23 (e.g., a gift box image) so that the gift content overlays at least some area (e.g., an upper area of the target image of the curved surface object 18) of the photographing image on the display 12. In this case, the gift content 23 may be slightly moved up and down. In this case, the gift content 23 may be provided in return for a user who has listened to (or watched) various types of information descriptions related to the corresponding curved surface object 18 through the object 22 based on the image content. Meanwhile, when receiving a touch input of the user for the gift content 23, the processor 16 notifies the server 50 of the touch input. The processor 16 may receive gift information (e.g., including text reading that predetermined cash, etc. is provided) corresponding to the gift content 23 from the server 50, and may play back the received gift information so that the received gift information overlays at least some area of the corresponding curved surface object 18 on the display 12 by interpreting the received gift information. In this case, the processor 16 may control the gift information to overlay the at least some area of the corresponding curved surface object 18 as the gift content 23 on the display 12 bursts. If necessary, the processor 16 may control the gift content 23 to overlay an area that is spaced apart from the curved surface object 18, but is near the curved surface object 18.

On the one hand, although not illustrated in the drawing, the processor 16 may play back the image content received from the server 50 so that the image content is spaced apart from the curved surface object 18 on the display 12 and overlays an area near the curved surface object 18. For example, the processor 16 may control the object 22 based on the image content to slowly move from the back or front of the curved surface object 18 on the display 12 to the left or right side and to be placed in an area near the corresponding curved surface object 18. On the one hand, the processor 16 may make the object 22 based on the image content stick out to an area near the corresponding curved surface object 18 on an upper part of the curved surface object 18 on the display 12 so that the object overlays the area near the corresponding curved surface object 18.

Accordingly, according to an embodiment of the present disclosure, the processor 16 may need to determine that a target image has been disposed in any shape, among a plane shape and a curved shape. The processor 16 may play back corresponding image content based on a result of the determination.

For example, the processor 16 may extract an area in which a target image within a photographing image has been disposed, may calculate the curvature (i.e., may be said to be the curvature of the target image) of the extracted area, and may determine that the corresponding target image has been disposed in a plane shape when the calculated curvature is less than a preset reference value. When determining that the target image has been disposed in the plane shape as described above, the processor 16 may detect the outer trajectory of the corresponding target image in the photographing image, and may play back image content received from the server 50 within the detected outer trajectory of the target image. In this case, the image content received from the server 50 will be image content that has been set to be played back within the area of the target image on the display 12 of the mobile terminal 10.

Meanwhile, the processor 16 may extract an area in which a target image within a photographing image has been disposed, may calculate the curvature (i.e., may be said to be the curvature of the target image) of the extracted area, and may determine that the corresponding target image has been disposed in a curved shape when the calculated curvature is equal to or greater than a preset reference value. When determining that the target image has been disposed in the curved shape as described above, the processor 16 may play back image content on the display 12 in the state in which the outer trajectory of the image content received from the server 50 has not been matched with the outer trajectory of the corresponding target image. In this case, the image content received from the server 50 will be image content that has been set so that the image content overlays at least some area of the photographing image on the display 12 of the mobile terminal 10.

Accordingly, when transmitting the identifier of a subject image corresponding to the target image to the server 50, the processor 16 may designate a first flag value meaning that the target image has been disposed in the plane shape or a second flag value meaning that the target image has been disposed in the curved shape, and may also transmit the first flag value and the second flag value. Thereafter, the server 50 selects image content according to a predetermined rule or randomly, among a plurality of pieces of image content associated with the subject image, and then transmits the image content to the mobile terminal 10. In this case, when determining that the target image has been disposed in the plane shape through the received flag value, the server 50 will transmit the image content which may be played back within an area of the target image on the display 12. Meanwhile, when determining that the target image has been disposed in the curved shape through the received flag value, the server 50 will transmit the image content which may overlay at least some area of the photographing image on the display 12. Accordingly, the processor 16 of the mobile terminal 10 has only to play back the received image content on the display 12 because the processor receives the image content suitable for the plane shape or the image content suitable for the curved shape. In such a case, the server 50 may consider that first image content suitable for the plane shape and second image content suitable for the curved shape are included in the pieces of image content, respectively. Accordingly, the server 50 selects image content according to a predetermined rule or randomly, among a plurality of pieces of image content associated with the subject image, and transmits the selected image content to the mobile terminal 10, but may select the first image content suitable for the plane shape or the second image content suitable for the curved shape based on the received flag value, and may transmit the first image content or the second image content to the mobile terminal 10.

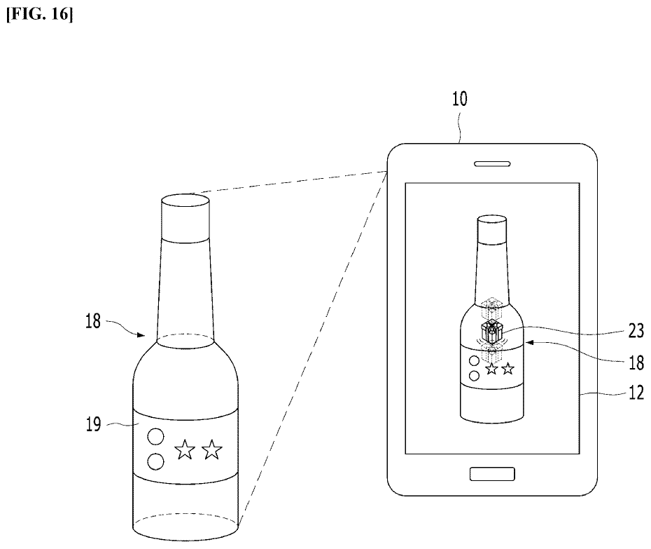

In FIG. 11, a movie poster has been described as an example, but advertising (refer to FIG. 17) of a bus station shelter may be described as an example.

An edge pattern 8 having a quadrangle indicated by an alternate long and short dash line has been inserted into (printed on) the advertising of the bus station shelter exemplified in FIG. 17.

A user photographs the corresponding advertising by directing the camera 11 of the mobile terminal 10 toward the advertising of the bus station shelter so that the portion of the edge pattern 8 can be seen to the display 12. Thereafter, a photographing image is displayed on the display 12 of the mobile terminal 10. In this case, the photographing image is an image displayed on the entire front surface of the display 12, and may include the edge pattern 8 and an image within an area surrounded by the edge pattern 8. The photographing image may also include other image in addition to the edge pattern 8 exemplified in FIG. 17 and the image within the area surrounded by the edge pattern 8.

The processor 16 extracts a target image from the photographing image. For example, in FIG. 17, the target image is an image within the area surrounded by the edge pattern 8. Accordingly, the processor 16 searches the photographing image for the edge pattern 8 and extracts the image within the area surrounded by the edge pattern 8 as the target image.

Thereafter, the processor 16 extracts a subject image corresponding to the target image, among a plurality of candidate images stored in the memory 14.

When the target image is extract from the photographing image and the subject image corresponding to the target image is extracted as described above, it may be said that the photographing image has been recognized.

Thereafter, the processor 16 transmits the extracted subject image to the server 50 through the communication unit 15, and may preferably transmit the identifier of the extracted subject image to the server 50. In the case of FIG. 17, the server 50 will transmit a video that is selected according to a predetermined rule or randomly, among a plurality of videos associated with the corresponding subject image, based on the identifier of the received subject image to the mobile terminal 10 so that the video can be played back within an area of the target image 9 on the display 12 of the mobile terminal 10.

Accordingly, the processor 16 may play back the video received through the communication unit 15 within the area of the target image 9 (refer to FIG. 17) on the display 12. That is, in the case of FIG. 17, the processor 16 may play back the received video within the area of the target image 9 on the display 12 because the target image, that is, the area surrounded by the edge pattern 8, has been disposed in a plane shape. For example, the processor 16 may play back the video with augmented reality.

Control operations of the processor 16 in a case in which candidate images have not been stored in the memory 14 of FIG. 6 are described.

In FIG. 6, if candidate images have not been stored in the memory 14, the processor 16 extracts a target image from a photographing image captured by the camera 11, and transmits the extracted target image to the server 50 through the communication unit 15. For example, the processor 16 may search the photographing image (i.e., an image displayed on the entire display area of the display 12) for a predetermined edge pattern, may determine an area surrounded by the edge pattern as an area of the target image, and may extract an image within the determined area as the target image. Accordingly, the server 50 extracts a subject image corresponding to the target image, among a plurality of candidate images that has been previously stored.

Furthermore, the server 50 will transmit a video that is selected according to a predetermined rule or randomly, among a plurality of videos associated with the extracted subject image, to the mobile terminal 10 so that the video can be played back within the area of the target image on the display 12 of the mobile terminal 10. Accordingly, the processor 16 plays back the video received through the communication unit 15 within the area of the target image on the display 12. For example, the processor 16 may play back the video with augmented reality.

If necessary, the server 50 may transmit the video selected as described above to the mobile terminal 10 so that the video can overlay at least some area of the photographing image on the display 12 of the mobile terminal. Accordingly, the processor 16 may play back the video received through the communication unit 15 so that the video overlays at least some area of the photographing image on the display 12.

Meanwhile, in the extraction of a target image in the processor 16 in a case in which candidate images have not been stored in the memory 14, the target image may be extracted from a current photographing image only when an extraction command, such as a touch input of a user or the recognition of a QR code, is received. This may help to reduce a load in the mobile terminal 10 because the unnecessary extraction of the target image is prevented.

In addition to the contents, the processor 16 may extract a target image by detecting a predetermined edge pattern (e.g., an edge pattern having a quadrangle). Furthermore, although the outer trajectory of the target image is not a quadrangle, the processor 16 may detect the outer trajectory of the corresponding target image as described based on FIG. 13, and may play back a video from the server 50 within the detected outer trajectory of the target image.

As described above, the processor 16 in the case in which candidate images have not been stored in the memory 14 is merely functionally different from the processor 16 in the case in which candidate images have been stored in the memory 14 in that a subject image corresponding to a target image may not be extracted, and others are similar.

A difference between the functions of the processor 16 based on the cases in which candidate images have been stored or have not been stored in the memory 14 has been described above. If necessary, the processor 16 operates two modes together, but may select one mode, among the two modes, according to circumstances and perform a corresponding control operation. For example, a first mode is a mode that is activated in a case in which candidate images have been stored in the memory 14. A second mode is a mode that is activated in a case in which candidate images have not been stored in the memory 14.

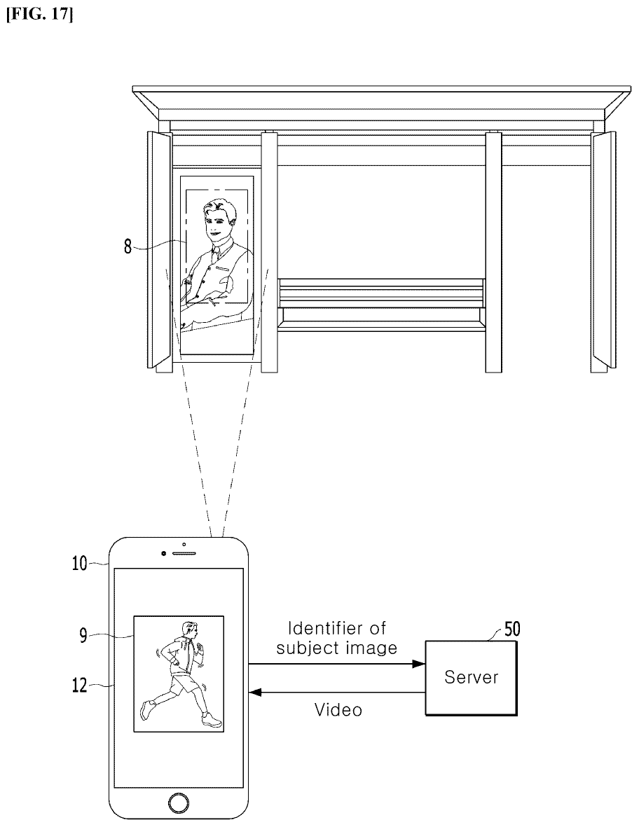

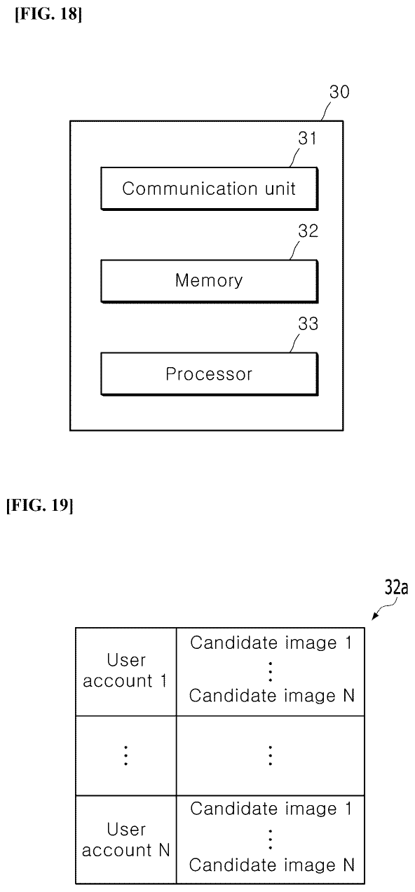

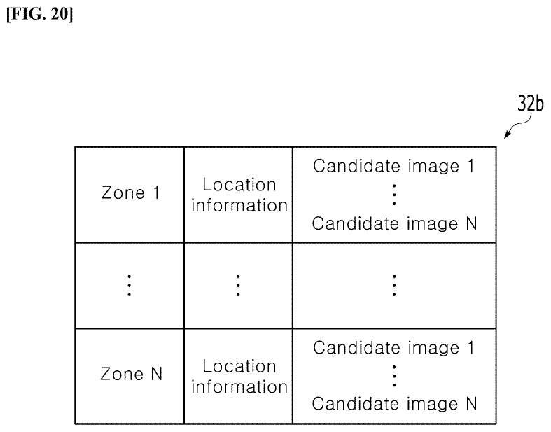

FIG. 18 is an internal construction diagram of the image server 30 illustrated in FIG. 5. FIG. 19 is a diagram that is adopted to describe a case in which candidate images are stored in memory illustrated in FIG. 18 in association with a user account. FIG. 20 is a diagram that is adopted to describe a case in which candidate images are stored in the memory illustrated in FIG. 18 in association with location information.

The image server 30 may include a communication unit 31, memory 32, and a processor 33. The image server 30 may be an example of a first server written in the claims of the present disclosure.

The communication unit 31 may perform communication with the mobile terminal 10 and the video server 40.

The memory 32 may store a plurality of candidate images. The mobile terminal 10 may select a representative frame, among the frames of a video photographed by the camera 11, and may upload the representative frame (i.e., a representative image) into the server 50 by associating the representative frame with the corresponding video by using the representative frame as a candidate image. The representative image is not selected from the photographed corresponding video, but an image different from the corresponding video may be selected as the representative image. Accordingly, the plurality of candidate images stored in the memory 32 may be considered as having been generated by the mobile terminal 10 and stored therein.

The memory 32 may store at least some of the candidate images by associating the at least some of the candidate images with a user account. For example, as illustrated in FIG. 19, the candidate images may be stored in the memory 32 in the form of a lookup table 32a in association with a user account. In this case, each user account may mean the account of each mobile terminal user. The reason for this is that if only candidate images of a corresponding user account are compared with a target image when the target image and the candidate images are compared, a subject image corresponding to the target image, among the candidate images, can be extracted more rapidly.

Meanwhile, the candidate images stored in the memory 32 may be stored in association with location information. In this case, the location information may mean information on the location of a zone. Accordingly, as illustrated in FIG. 20, the candidate images may be stored in the memory 32 in the form of a lookup table 32b in association with information on the location of a zone. For example, first to fifth candidate images may be stored in association with location information that means a zone 1.

Meanwhile, although not illustrated in the drawings, the candidate images stored in the memory 32 may be stored in association with time information. For example, association with time information may be necessary because videos associated with a subject image (i.e., a candidate image) can be played back only during the time when a museum is open.

Although not illustrated in the drawings, at least some of the candidate images stored in the memory 32 may be stored in association with a physical object. In this case, the physical object may be a book, such as a math workbook, a cookbook, a knitting book, or an encyclopedia, and may be a museum, an exhibit hall, etc. in addition to a book. For example, a candidate image and a corresponding physical object (e.g., a mathematical workbook) may be associated and stored in the memory 32 by using the body or image (a mathematical problem) of a book as a candidate image.

In FIG. 18, the processor 33 may control an overall operation of the image server 30.

The processor 33 may mean a device capable of performing a series of operations or determinations for an operation of the image server 30. For example, the processor 33 may be a central processing unit (CPU), a micro controller unit (MCU), a graphical processing unit (GPU), an application specific integrated circuit (ASIC), or a field programmable gate array (FPGA), but the present disclosure is not limited thereto.

The processor 33 may receive a target image extracted from a photographing image from the mobile terminal 10 through the communication unit 31.

The processor 33 may extract a subject image corresponding to a target image, among candidate images stored in the memory 32. When the subject image corresponding to the target image is extracted as described above, it may be considered that a corresponding photographing image has been recognized.

When receiving the target image, the processor 33 may also receive information on the curved surface of an object in which a corresponding target image has been disposed. When receiving the target image and the information on the curved surface of the object in which the target image has been disposed, the processor 33 may perform complanation based on the information on the curved surface on which the target image has been received, and may then extract a subject image.

Meanwhile, the processor 33 may extract the subject image corresponding to the target image, among candidate images associated with the user account of the mobile terminal received from the communication unit 31. As described above, if only the candidate images of the user account of a corresponding mobile terminal are compared with a target image, a subject image corresponding to the target image, among the candidate images, can be extracted more rapidly compared to a case in which all of the candidate image stored in the memory 32 are compared with the target image.

The processor 33 may perform sharing processing on candidate images which may be queried (compared). For example, it is assumed that five candidate images associated with the account of a user A have been stored in the memory 32, ten candidate images associated with the account of a user B have been stored in the memory 32, and seven candidate images associated with the account of a user C have been stored in the memory 32. The user A may transmit a request to share the candidate images of his or her account and the candidate images associated with the account of the user B to the image server 30. Accordingly, the processor 33 performs sharing processing on the candidate images associated with the account of the user A and the candidate images associated with the account of the user B. Accordingly, the processor 33 may extract a subject image corresponding to a target image, among the candidate images associated with the account of the user A and the candidate images associated with the account of the user B.

Meanwhile, the processor 33 may extract a subject image corresponding to a target image, among candidate images (i.e., candidate images stored in the memory 32) associated with information on a location near the current location of the mobile terminal 10. For example, when the current location of the mobile terminal 10 corresponds to information on the location of a zone 1, the processor 33 may extract a subject image corresponding to a target image, among candidate images associated with the information on the location of the zone 1. If candidate images have been stored in association with location information that means a zone as described above, the processor 33 can extract a subject image corresponding to a target image more rapidly through only a comparison with candidate images associated with information on a location near the current location of the mobile terminal 10 not a comparison with all of the candidate images.

The processor 33 may extract a subject image corresponding to a target image, among candidate images associated with time information to which the current time of a corresponding mobile terminal 10 belongs because the candidate images may have been stored in the memory 32 in association with time information.

Meanwhile, the processor 33 may also receive information on a physical object in which a corresponding target image has been displayed when receiving the target image from the mobile terminal 10 because at least some of candidate images may have been stored in the memory 32 in association with the physical object (e.g., a book, a museum, or an exhibit hall). If a target image and information on a physical object in which the corresponding target image has been displayed are received as described above, the processor 33 can extract a subject image corresponding to the corresponding target image, among candidate images associated with the physical object.

The processor 33 may provide the extracted subject image to the video server 40. Preferably, the processor 33 will transmit the identifier of the extracted subject image to the video server 40.

The processor 33 may provide the extracted subject image to the video server 40. Preferably, the processor 33 will transmit the identifier of the extracted subject image to the video server 40.

The processor 33 may store one or more instructions in memory that is internally provided, and may perform control so that the aforementioned operations are performed by executing the one or more instructions stored in the memory that is internally provided. That is, the processor 33 may perform a function of the image server 30 by executing at least one instruction or program stored in the internal memory that is provided within the processor 33 or the memory 32. In this case, the memory 32 may store one or more instructions executable by the processor 33.

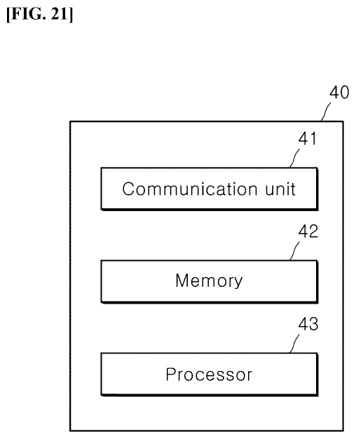

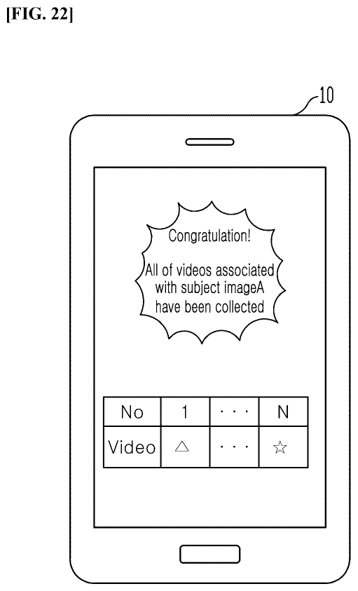

FIG. 21 is an internal construction diagram of the video server 40 illustrated in FIG. 5. FIG. 22 is a diagram that is adopted to describe a case in which a video collection completion event signal is transmitted from the server to the mobile terminal.

The video server 40 may include a communication unit 41, memory 42, and a processor 43. The video server 40 may be an example of a second server written in the claims of the present disclosure.

The communication unit 41 may perform communication with the mobile terminal 10 and the image server 30.

The memory 42 may store a plurality of videos associated with a candidate image.

The processor 43 may control an overall operation of the video server 40.

The processor 43 may mean a device capable of performing a series of operations or determinations for an operation of the video server 40. For example, the processor 43 may be a central processing unit (CPU), a micro controller unit (MCU), a graphical processing unit (GPU), an application specific integrated circuit (ASIC), or a field programmable gate array (FPGA), but the present disclosure is not limited thereto.

The processor 43 may receive a subject image from the image server 30 through the communication unit 41. Preferably, the processor 43 will receive the identifier of the subject image.

The processor 43 may select a video according to a predetermined rule or randomly, among a plurality of videos associated with the subject image, and may transmit the selected video to the mobile terminal 10 through the communication unit 41 so that the selected video can be played back within an area of a target image on the display of the mobile terminal 10. In this case, the predetermined rule may be the choice probability of each of the plurality of videos associated with the subject image as described above. The predetermined rule may mean that videos are sequentially selected one by one each time. The writing “randomly” may mean that videos are randomly selected regardless of a predetermined rule. The processor 43 may transmit the selected video to the mobile terminal 10 so that the selected video can be played back within an area of the target image on the display of the mobile terminal 10 because the processor 43 has received a first flag value meaning that the target image has been disposed in a plane shape from the mobile terminal 10.

In contrast, the processor 43 may transmit the video selected as described above to the mobile terminal 10 through the communication unit 41 so that the video overlays at least some area of a photographing image on the display of the mobile terminal 10. The processor 43 may transmit the selected video to the mobile terminal 10 so that the selected video overlays at least some area of the photographing image on the display of the mobile terminal 10 because the processor 43 has received a second flag value meaning that the target image has been disposed in a curved shape from the mobile terminal 10. In this case, the overlaying of the video on at least some area of the photographing image on the display of the mobile terminal 10 may mean that the video is played back on the display in the state in which the outer trajectory of the video has not been matched with the outer trajectory of the target image. Furthermore, the overlaying of the video on at least some area of the photographing image on the display of the mobile terminal 10 may be understood as overlaying the video on at least some area of the target image on the display.

Meanwhile, the processor 43 may select a video that is selected with respect to the same subject image differently from a video that is previously selected with respect to the same subject image. A more detailed description thereof may be sufficiently understood by those skilled in the art with reference to a part described with reference to FIG. 7.

Meanwhile, a video that is selected by the processor 43 according to a predetermined rule or randomly, among a plurality of videos associated with a subject image, may include predetermined indication contents of a user. A more detailed description thereof may be sufficiently understood by those skilled in the art with reference to a part described with reference to FIG. 9.

Meanwhile, a video that is selected by the processor 43 according to a predetermined rule or randomly, among a plurality of videos associated with a subject image, may include coupon content. That is, it may be considered that a probability has been grafted onto the provision of a coupon. Accordingly, a coupon may be provided according to the choice probability of each coupon.

Meanwhile, the processor 43 may perform a transmission record by associating the user account of a corresponding mobile terminal with a video transmitted to the mobile terminal 10. Accordingly, if a transmission record has been performed by associating all of a plurality of videos associated with a subject image with the user account of a corresponding mobile terminal, the processor 43 may transmit a video collection completion event signal to the corresponding mobile terminal. When the video collection completion event signal is received as described above, a notification message, such as that exemplified in FIG. 22, may be displayed on the display of the corresponding mobile terminal. In this case, the notification message may include a text message that provides notification that all of videos associated with a subject image have been collected, a data list having a table form in which all of the videos collected in association with the corresponding subject image have been listed, etc. A user's need for the collection of videos can be maximized because the video collection completion event signal can be transmitted to the mobile terminal 10 as described above.

Meanwhile, a transmission times limit value of a video that is selected, among a plurality of videos (an example of image content) associated with a corresponding subject image with respect to the same subject image, may have been set in the processor 43. Accordingly, when the transmission times limit value is exceeded with respect to a corresponding user, the processor 43 does not transmit a video selected with respect to a corresponding subject image to the mobile terminal 10. In other words, the number of times that a video is selected and transmitted with respect to one subject image may be limited (set) in the processor 43 for each user like 3 times or 5 times, for example. Accordingly, when a transmission times limit value on which a video is selected and transmitted with respect to one subject image for each user is exceeded, the processor 43 does no longer transmit a video to the mobile terminal 10 of a corresponding user whose transmission times limit value has been exceeded.

If necessary, the transmission times limit value may be a transmission times limit value within a predetermined period. For example, a transmission number within a corresponding period may be limited by determining a period, such as once a day or 5 times a month.

A more detailed example is proposed and described as follows. For example, it is assumed that the transmission times limit value for one subject image has been set to “3” with respect to the user of a mobile terminal A. Under the assumption, the processor 43 may select one of a plurality of videos related to a subject image (e.g., a subject image K) and transmit the selected video to the mobile terminal A. In this case, the processor 43 may transmit a video by a maximum number of three times to the mobile terminal A with respect to the corresponding subject image (e.g., the subject image K) because the transmission times limit value of the user of the mobile terminal A is “3”. If the mobile terminal A transmits the corresponding subject image (e.g., the subject image K) to the server 50 again after receiving the video three times with respect to the corresponding subject image, the processor 43 of the video server 40 of the server 50 does not transmit a selected video to the mobile terminal A of the corresponding user although the one video is selected among a plurality of videos associated with the corresponding subject image. As described above, the processor 43 determines a transmission times limit value on which a video is selected and transmitted with respect to one subject image for each user. Accordingly, the mobile terminal of a user whose transmission times limit value is exceeded does no longer receive a video because a video that is selected, among a plurality of videos related to a corresponding subject image, is no longer transmitted to the mobile terminal of the user whose transmission times limit value is exceeded.

Meanwhile, the transmission time range of a video that is selected with respect to a subject image may be set in the processor 43. Accordingly, when a current time does not belong to the transmission time range, the processor 43 does not transmit a video that is selected with respect to the corresponding subject image to the mobile terminal 10.

Meanwhile, the processor 43 may select a video, among a plurality of videos associated with a subject image, based on information on the current location of the mobile terminal 10. In this case, if necessary, the number of videos that is selected and transmitted in association with the subject image may be limited in association with a location. For example, a degree of difficulty of the collection of videos can be increased and a reward effect for the collection of videos can be doubled by allowing only one video to be transmitted at one location.

The processor 43 may store one or more instructions in memory that is internally provided, and may perform control so that the aforementioned operations are performed by executing the one or more instructions stored in the memory that is internally provided. That is, the processor 43 may perform a function of the video server 40 by executing at least one instruction or program stored in the internal memory provided within the processor 43 or the memory 42. In this case, the memory 42 may store one or more instructions executable by the processor 43.

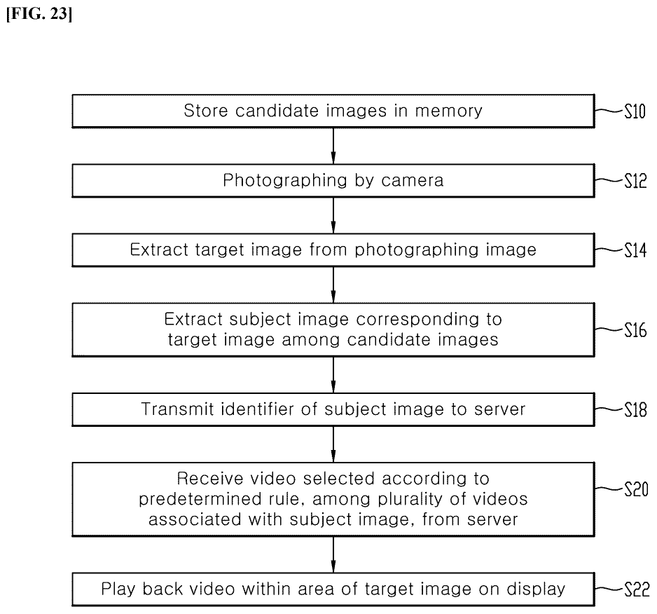

FIG. 23 is a flowchart for describing a control method in the mobile terminal according to an embodiment of the present disclosure.

First, a plurality of candidate images is stored in the memory 14 of the mobile terminal 10 (S10). For example, the mobile terminal 10 may photograph a video and select a representative frame, among the frames of a photographed video. The mobile terminal 10 may upload the representative frame into the server 50 by associating the representative frame with the corresponding video by using the representative frame as a candidate image (i.e., a representative image). In this case, the processor 16 of the mobile terminal 10 may store the generated candidate image in the memory 14.

Next, the user photographs a desired photographing subject (e.g., a product label, a menu, the advertising of a bus station shelter, a movie poster, a concert poster, a book, company introduction, or a liquor bottle or milk pack with a product label) and surroundings thereof through the camera 11 of the mobile terminal 10 (S12). Only a desired photographing subject may be photographed.

Next, the mobile terminal 10 extracts a target image from a photographing image (i.e., an image displayed on the entire front surface of the display 12) captured by the camera 11 (S14). The target image may mean an image of an area in which a subject to be recognized within the photographing image is present. For example, the target image may mean an image of an area which may be said to be an interested area in the photographing image.

A predetermined edge pattern may be inserted into (printed on) the photographing subject. If the user has photographed a photographing subject having an edge pattern through the camera 11, the processor 16 of the mobile terminal 10 may search the photographing image for the edge pattern. Thereafter, the processor 16 of the mobile terminal 10 may determine an area surrounded by the edge pattern as an area of the target image and extract an image within the determined area as the target image. Thus, the processor 16 of the mobile terminal 10 can extract the target image more rapidly through the edge pattern because the area which may be said to be the interested area has been indicated by the edge pattern. If an edge pattern is present compared to a case in which the edge pattern is not present in a photographing subject, the time required until a target image is searched for in the photographing image will be reduced.

Thereafter, the processor 16 of the mobile terminal 10 extracts a subject image corresponding to the target image, among a plurality of candidate images stored in the memory 14 (S16).

If the mobile terminal 10 extracts the subject image corresponding to the target image as described above, the recognition of an image by the server 50 becomes necessary because the photographing image is recognized. Accordingly, a load that is applied to the server 50 can be reduced because the server 50 does not need to recognize an image.

The mobile terminal 10 transmits the extracted subject image to the server 50. Preferably, the mobile terminal transmits the identifier of the extracted subject image to the server 50 (S18).

Accordingly, the server 50 searches the plurality of candidate images stored in the memory 32 therein for a candidate image corresponding to the received subject image. Furthermore, the server 50 transmits a video that is selected according to a predetermined rule or randomly, among a plurality of videos associated with the retrieved candidate image (i.e., the subject image), to the mobile terminal 10 so that the video can be played back within an area of the target image 9 on the display 12 of the mobile terminal 10. This may be a case in which the server 50 has received a first flag value meaning that the target image has been disposed in a plane shape from the mobile terminal 10.

Accordingly, the mobile terminal 10 receives the video from the server 50 (S20), and plays back the received video within the area of the target image on the display 12 (S22). In this case, the video may be displayed with augmented reality.

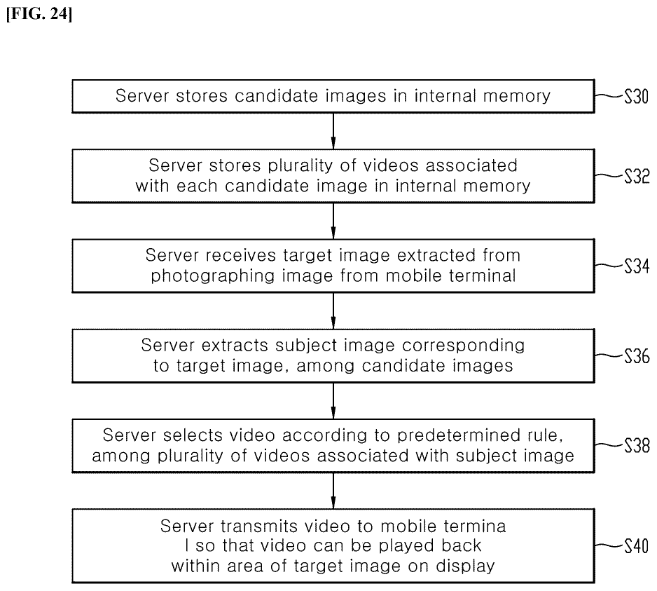

FIG. 24 is a flowchart for describing a control method in the server according to an embodiment of the present disclosure.

First, the server 50 (preferably, the image server 30) stores a plurality of candidate images in the internal memory 32 (S30). The video server 50 (preferably, the video server 40) stores a plurality of videos associated with each candidate image in the internal memory 42 (S32).

The server 50 may receive a subject image (preferably, the identifier of the subject image) from the mobile terminal 10. However, a case in which the server receives a target image is described below.

Accordingly, the server 50 (preferably, the image server 30) receives a target image extracted from a photographing image from the mobile terminal 10 (S34). If necessary, the server 50 may receive the photographing image from the mobile terminal 10 and extract the target image from the received photographing image. In such a case, however, a load of the server 50 may be increased. Accordingly, it may be preferred that the target image extracted from the photographing image is received from the mobile terminal 10 if possible.

Next, the server 50 (preferably, the image server 30) extracts a subject image corresponding to the target image, among the plurality of candidate images stored in the memory 32 (S36).

Furthermore, the server 50 (preferably, the video server 40) reads a plurality of videos associated with the extracted subject image from the memory 42, and selects any one video according to a predetermined rule or randomly, among the plurality of videos (S38).

Next, the server 50 (preferably, the video server 40) transmits the selected video to the mobile terminal 10 so that the selected video can be played back within an area of the target image on the display 12 of the mobile terminal 10 (S40). This may be a case in which the server 50 (preferably, the video server 40) has received a first flag value meaning that the target image has been disposed in a plane shape from the mobile terminal 10.

Thus, the mobile terminal 10 plays back the received video within the area of the target image on the display 12. In this case, the video may be displayed with augmented reality.

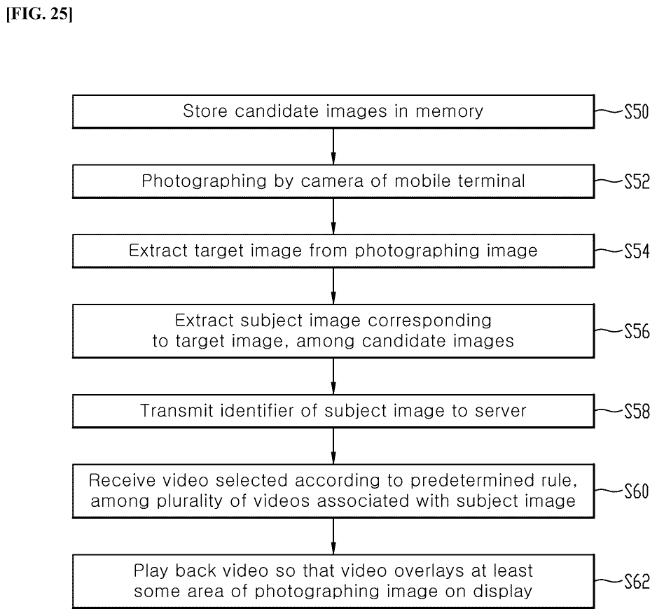

FIG. 25 is a flowchart for describing a control method in the mobile terminal according to another embodiment of the present disclosure.

First, a plurality of candidate images is stored in the memory 14 of the mobile terminal 10 (S50). For example, the mobile terminal 10 may photograph a video and select a representative frame, among the frames of the photographed video. The mobile terminal 10 may upload the representative frame into the server 50 by associating the representative frame with the corresponding video by using the representative frame as a candidate image (i.e., a representative image). In this case, the processor 16 of the mobile terminal 10 may store the generated candidate image in the memory 14.

Next, a user photographs a desired photographing subject (e.g., a product label, a menu, the advertising of a bus station shelter, a movie poster, a concert poster, a book, company introduction, or a liquor bottle or milk pack with a product label) and surroundings thereof through the camera 11 of the mobile terminal 10 (S52). Only a desired photographing subject may be photographed.

Next, the mobile terminal 10 extracts a target image from a photographing image (i.e., an image displayed on the entire front surface of the display 12) captured by the camera 11 (S54). The target image may mean an image of an area in which a subject to be recognized within the photographing image is present. For example, the target image may mean an image of an area which may be said to be an interested area within the photographing image.

A predetermined edge pattern may be inserted into (printed on) the photographing subject. If a user has photographed a photographing subject having an edge pattern through the camera 11, the processor 16 of the mobile terminal 10 may search the photographing image for the edge pattern. Thereafter, the processor 16 of the mobile terminal 10 may determine an area surrounded by the edge pattern as the area of a target image, and may extract an image within the determined area as the target image. In such a case, the processor 16 of the mobile terminal 10 can extract the target image more rapidly through the edge pattern because the area which may be said to be an interested area has been indicated by the edge pattern. If an edge pattern is present in a case in which the edge pattern is not present in a photographing subject, the time required until a target image is searched for in the photographing image will be reduced.

Thereafter, the processor 16 of the mobile terminal 10 extracts a subject image corresponding to the target image, among the plurality of candidate images stored in the memory 14 (S56).

When the mobile terminal 10 extracts the subject image corresponding to the target image as described above, the recognition of an image by the server 50 is not necessary because the photographing image has been recognized. Accordingly, a load that is applied to the server 50 can be reduced because the server 50 does not need to recognize an image.

The mobile terminal 10 transmits the extracted subject image to the server 50. Preferably, the mobile terminal transmits the identifier of the extracted subject image to the server 50 (S58).

Accordingly, the server 50 searches the plurality of candidate images stored in the internal memory 32 for a candidate image corresponding to the received subject image. Furthermore, the server 50 transmits a video that is selected according to a predetermined rule or randomly, among a plurality of videos associated with the retrieved candidate image (i.e., the subject image), to the mobile terminal 10 so that the video overlays at least some area of the photographing image on the display 12 of the mobile terminal 10. This may be a case in which the server 50 has received a second flag value meaning that the target image has been disposed in a curved shape from the mobile terminal 10.

Accordingly, the mobile terminal 10 receives the video from the server 50 (S60).

Thereafter, the mobile terminal 10 plays back the received video so that the received video overlays at least a part of the photographing image on the display 12 (S62). For example, after detecting the curved surface object 18 in which the target image has been disposed in the photographing image, the mobile terminal 10 may make an object (e.g., a person) (a three-dimensional object) based on the video stick out (pop up) in front of the curved surface object 18 on one side (e.g., an upper side) of the curved surface object 18 on the display 12. Furthermore, the processor 16 of the mobile terminal 10 may make the popped-up object 22 adopt a posture in which the popped-up object has sit on the chair with one leg placed on the other leg in front of the curved surface object 18 on the display 12. Furthermore, the processor 16 of the mobile terminal 10 may make a motion of the object 22 that describes the curved surface object 18 played back, and may output a predetermined description of the curved surface object 18 in voice.

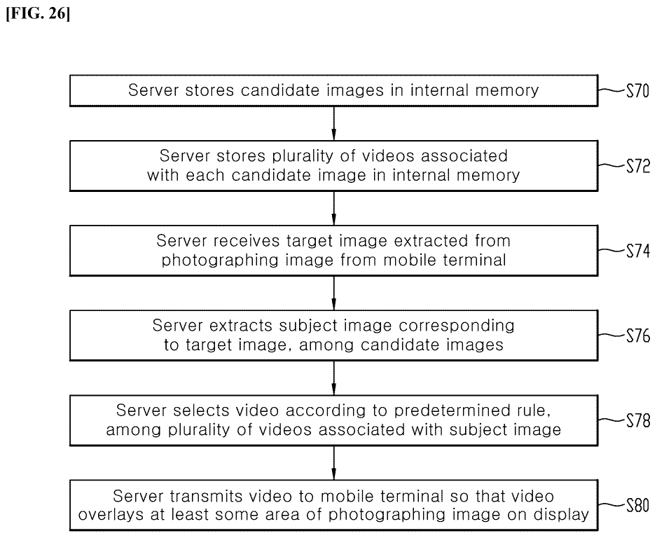

FIG. 26 is a flowchart for describing a control method in the server according to another embodiment of the present disclosure.

First, the server 50 (preferably, the image server 30) stores a plurality of candidate images in the internal memory 32 (S70). The video server 50 (preferably, the video server 40) stores videos associated with each candidate image in the internal memory 42 (S72).

The server 50 may receive a subject image (preferably, the identifier of the subject image) from the mobile terminal 10. However, a case in which the server receives a target image is described below.

Accordingly, the server 50 (preferably, the image server 30) receives a target image extracted from a photographing image from the mobile terminal 10 (S74). If necessary, the server 50 may receive the photographing image from the mobile terminal 10 and extract the target image from the received photographing image. However, in such a case, a load of the server 50 may be increased. Accordingly, it will be preferred that the server receives the target image extracted from the photographing image from the mobile terminal 10 if possible.

Next, the server 50 (preferably, the image server 30) extracts a subject image corresponding to the target image, among the plurality of candidate images stored in the memory 32 (S76).

Furthermore, the server 50 (preferably, the video server 40) reads a plurality of videos associated with the extracted subject image from the memory 42, and selects any one video according to a predetermined rule or randomly, among the plurality of read videos (S78).

Next, the server 50 (preferably, the video server 40) transmits the selected video to the mobile terminal 10 so that the selected video overlays at least some area of the photographing image on the display 12 of the mobile terminal 10 (S80). This may be a case in which the server 50 (preferably, the video server 40) has received a second flag value meaning that the target image has been disposed in a curved shape from the mobile terminal 10.

Thus, the mobile terminal 10 plays back the received video so that the received video overlays at least some area of the photographing image on the display 12.

On the one hand, a sticker photographer may be used instead of the mobile terminal described in the aforementioned embodiments. When photographing a video, the sticker photographer may select a representative frame, among the frames of the photographed video, as a representative image, and may print the corresponding representative image. Furthermore, the sticker photographer uploads the representative image and the video into the server by associating the representative image and the video. Thereafter, if the representative image that has been printed is photographed if necessary, videos associated with the corresponding representative image may be received from the server and played back through the aforementioned operation.

Furthermore, the method according to an embodiment of the present disclosure may also be implemented as a computer-readable code in a computer-readable recording medium. The computer-readable medium includes all types of recording media in which data readable by a computer system is stored. Examples of the computer-readable medium include ROM, RAM, CD-ROM, a magnetic tape, a floppy disk, and an optical data storage device. Furthermore, the computer-readable recording medium may be distributed to computer systems connected over a network so that a computer-readable code can be stored and executed in a distributed manner. Furthermore, functional programs, codes, and code segments for implementing the above method may be easily inferred by programmers of the technical field to which the present disclosure belongs.

The above description is merely a description of the technical spirit of the present disclosure, and those skilled in the art may change and modify the present disclosure in various ways without departing from the essential characteristic of the present disclosure. Accordingly, the embodiments disclosed in the present disclosure should not be construed as limiting the technical spirit of the present disclosure, but should be construed as describing the technical spirit of the present disclosure. The technical spirit of the present disclosure is not restricted by the embodiments. The range of protection of the present disclosure should be construed based on the following claims, and all of technical spirits within an equivalent range of the present disclosure should be construed as being included in the scope of rights of the present disclosure.

1. A mobile terminal comprising:
a camera;
a display;
memory in which candidate images are stored; and
a processor configured to extract a target image from a photographing image captured by the camera, extract a subject image corresponding to the target image, among the candidate images, receive image content that is selected according to a predetermined rule, among a plurality of pieces of image content associated with the extracted subject image, from a server, and play back the received image content so that the received image content overlays at least some area of the photographing image on the display.

2. The mobile terminal of claim 1, wherein:
a transmission times limit value of image content that is selected, among a plurality of pieces of image content associated with an identical subject image, is set in the server, and
the processor does not receive image content selected with respect to a corresponding subject image from the server when the transmission times limit value of a corresponding user is exceeded.

3. The mobile terminal of claim 1, wherein the processor plays back the received image content on the display in a state in which an outer trajectory of the received image content has not been matched with an outer trajectory of the target image.

4. The mobile terminal of claim 1, wherein the processor plays back the received image content so that the received image content overlays at least some area of the target image on the display.

5. The mobile terminal of claim 1, wherein the processor
determines whether the target image has been disposed in any one shape, among a plane shape and a curved shape,
plays back the received image content within an outer trajectory of the target image on the display when determining that the target image has been disposed in the plane shape, and
plays back the received image content on the display in a state in which an outer trajectory of the received image content has not been matched with the outer trajectory of the target image when determining that the target image has been disposed in the curved shape.

6. The mobile terminal of claim 1, wherein the predetermined rule is a choice probability of each of the plurality of pieces of image content associated with the subject image.

7. The mobile terminal of claim 1, wherein the image content that is received with respect to an identical subject image is different from image content that is previously received with respect to the identical subject image.

8. The mobile terminal of claim 1, wherein the processor plays back image content that is selected based on information on a current location of the mobile terminal, among the plurality of pieces of image content associated with the subject image, and that is received from the server so that the image content overlays at least some area of the photographing image on the display.

9. The mobile terminal of claim 1, wherein the processor plays back the received image content within an area of the target image on the display.

10. The mobile terminal of claim 9, wherein the processor plays back image content that is selected based on information on a current location of a mobile terminal, among the plurality of pieces of image content associated with the subject image, and that is received from the server within the area of the target image on the display.

11. A system comprising:
a first server in which candidate images are stored; and
a second server in which a plurality of pieces of image content associated with each of the candidate images is stored,
wherein the second server selects image content according to a predetermined rule, among a plurality of pieces of image content associated with a subject image extracted among the candidate images, and transmits the selected image content to a mobile terminal so that the selected image content overlays at least some area of a photographing image on a display of the mobile terminal.

12. The system of claim 11, wherein the first server receives a target image from the mobile terminal and extracts a subject image corresponding to the target image, among the candidate images.

13. The system of claim 11, wherein the predetermined rule is a choice probability of each of the plurality of pieces of image content associated with the subject image.

14. The system of claim 11, wherein the second server selects image content that is selected with respect to an identical subject image differently from image content that is previously selected with respect to the identical subject image.

15. The system of claim 11, wherein the second server performs a transmission record by associating the image content transmitted to the mobile terminal and a user account of the corresponding mobile terminal.

16. The system of claim 15, wherein the second server transmits an image content collection completion event signal to the corresponding mobile terminal when the transmission record is performed by associating all of the plurality of pieces of image content associated with the subject image with the user account of the corresponding mobile terminal.

17. The system of claim 11, wherein:
a transmission times limit value of image content that is selected, among a plurality of pieces of image content associated with an identical subject image, is set in the second server, and
the second server does not transmit image content selected with respect to a corresponding subject image to the mobile terminal when the transmission times limit value for a corresponding user is exceeded.

18. The system of claim 17, wherein the transmission times limit value is a transmission times limit value within a predetermined period.

19. The system of claim 11, wherein:
a transmission time range of image content that is selected with respect to the subject image is the second server, and
the second server does not transmit the image content that is selected with respect to the corresponding subject image to the mobile terminal when a current time does not belong to the transmission time range.

20. The system of claim 11, wherein the second server selects image content based on information on a current location of the mobile terminal, among the plurality of pieces of image content associated with the subject image.
